(19) United States
(12) Patent Application Publication
(10) Pub. No.: US 2020/0051116 A1
(43) Pub. Date: Feb. 13, 2020

(54) DISTRIBUTION OF FRACTIONAL EQUITY REWARDS BASED ON PURCHASE BEHAVIOR

(71) Applicant: Bumped, Inc., Portland, OR (US)

(72) Inventors: David Nelsen, Lake Oswego, OR (US); Philip Bryan Hagen, Portland, OR (US); Jeffrey Press, Portland, OR (US); Aaron Wirick, Portland, OR (US); Cameron Knight, Portland, OR (US); Jason Zeiber, Scappoose, OR (US)

(21) Appl. No.: 16/537,452

(22) Filed: Aug. 9, 2019

Related U.S. Application Data
(60) Provisional application No. 62/717,638, filed on Aug. 10, 2018.

(51) Int. Cl. G06Q 30/02

(52) U.S. Cl. CPC G06Q 30/0232; G06Q 30/0216; G06Q 30/0233

(57) ABSTRACT

Herein disclosed are systems and methods for distributing fractional equity rewards to users of a loyalty platform based on tracked user loyalty purchases. The disclosed systems and methods may enable a reduction in time between a user loyalty purchase and distribution of a fractional equity reward determined based on the user loyalty purchase. In one example, by maintaining merchant deposit accounts within the loyalty platform, and by aggregating pending fractional equity rewards, a speed of fractional equity reward distribution may be increased. Further, the merchant deposit accounts may enable reduction of an amount of stock held in an inventory account of the loyalty platform. The disclosure is further directed towards reducing user frustration by displaying equity reward statuses indicating a status of a pending fractional equity reward, which may further include an indication of an estimated reward fulfillment time.

### CROSS REFERENCE TO RELATED APPLICATIONS

The present application claims priority to U.S. Provisional Patent Application No. 62/717,638, entitled “DISTRIBUTION OF FRACTIONAL EQUITY REWARDS BASED ON PURCHASE BEHAVIOR,” filed on Aug. 10, 2018. The entire contents of the above-identified application is hereby incorporated by reference for all purposes.

### FIELD

The present application relates to systems and methods for distributing fractional equity rewards to users of a loyalty platform based on purchase behavior.

### BACKGROUND AND SUMMARY

Conventional reward programs, such as mail-in rebates or reward points based programs, suffer because they fail to build user loyalty with a particular brand in the long term. One reason for this failure is that one-time rewards, like a rebate or a physical prize rewarded after redeeming a certain number of accumulated points, do little to align the interests of the user with the interests of the rewarding company beyond a certain limited time frame. Another factor limiting the success of conventional reward programs to generate user loyalty is the effort required on the part of the user to record and/or submit proof of purchases which may be eligible for a reward, such as when a user is required to enter a code or other proof of purchase into an online account in order to receive credit/points for the purchase, or when a proof of purchase must be mailed-in in order to receive a rebate. Additionally, in points based rewards programs, accrued points often come with an expiration date or date when the points must be redeemed by, thereby placing an additional burden on the user to hurriedly redeem their points and further exacerbating the inability of such programs to maintain user loyalty over the long term. Points frequently have no real value outside the scope of a rewards program and, as such, mean little to customers in the grand scheme of their financial picture. Furthermore, rewards programs often have unrealistic goals requiring many dollars spent and points earned in order to earn a small reward.

One approach to increase customer loyalty over the long term is to reward customers with shares of stock in the businesses they patronize. As shares of stock held by customers may establish a meaningful long term relationship between customers and brands, rewarding customers with an equity reward, as opposed to a cash reward, enables greater longer term loyalty and alignment of interests between customers and brands. However, as shares of stock are conventionally bought and sold on the open market as whole shares, and as the price for a single share of stock in a business may be substantial (for example, the price of Amazon stock at the time of writing is $1,829/share), it may be unrealistic to reward a customer purchase with a whole share of stock, such as when a purchase amount is relatively small (especially in comparison to a share price associated with the transacting business/brand). As such, the potential of equity reward programs to generate customer loyalty has remained unrealized and there is a recognized need to provide a method for rewarding customers with fractional shares of stock.

Conventional methods aimed at addressing these issues teach providing fractional shares of stock as rewards to customers who engage in promotional activity, wherein the fractional shares of stock may be transferred to the customer from an inventory containing a supply of whole shares of stock. In one example, when a customer is eligible to receive a $5 reward based on participation in a promotional activity with a business, that $5 reward may be in the form of $5 of stock in the business, which may take the form of a fractional share of stock and may be allocated to the customer from a supply of whole shares of stock stored in an inventory of the reward provider. Further, a supply of shares of stock in the inventory of the reward provider may increase based on the amount of fractional shares of stock held by all customers, such that the amount of shares of stock in the inventory account is equal to or greater than the cumulative amount of shares of stock held by all customers.

However, the inventors herein have identified several issues with the above approach. In one example, the conventional approach discussed above may require maintaining an inventory of whole shares of stock (for providing fractional equity rewards) which is equal to or greater than an aggregate number of shares of stock held by the customers. Such a method of inventory control may require increasing the amount of stock held in the inventory as the total amount of stock held by customers increases, which may result in a large number of shares of stock being held in the inventory with a correspondingly large financial risk assumed by the reward provider. In another example, the above approach fails to account or provide mitigating actions for situations in which a delay occurs between when a customer claims a reward and when that reward is allocated to the customer. Such delays may reduce the ability of rewards to incentivize customer behavior by decoupling the incentive (the reward) from the incentivized behavior in the mind of the customer. Reward allocation delays may occur for numerous reasons, especially in the case of rewards comprising fractional shares of stock which may require more processing time and are conventionally less liquid than whole shares of stock. In one example, a reward delay may occur when funds from a merchant to be used to purchase the reward are not immediately available (such as when funds from a merchant must be transferred from a bank account of the merchant to an account of the reward provider), or when the reward amount exceeds an amount shares of stock currently held in an inventory and therefore must be purchased from the open market. In such cases, the customer may feel frustrated by the delay and the lack of feedback regarding the reward.

The inventors herein have developed systems and methods which may enable distribution of fractional equity rewards to users with a reduced probability of reward delay, a reduced amount of shares of stock held in an inventory account, and with reduced user frustration. In a first example, a method comprising, determining a first fractional number of shares of stock in a business to reward a user based on a tracked user loyalty purchase conducted by the user with the business, displaying an equity reward status to the user, aggregating the first fractional number of shares of stock in the business with one or more pending equity rewards in the business to form an aggregate pending equity reward, responding to the aggregate pending equity reward being greater than a pending reward threshold by purchasing a whole number of shares of stock in the business, wherein the whole number of shares of stock is equal to or greater than the aggregate pending equity reward, transferring a portion of the whole number of shares of stock to a merchant facilitation account associated with the business, transferring a remainder of the whole number of shares of stock to a residual account, distributing the first fractional number of shares of stock in the business to a reward account of the user from the merchant facilitation account associated with the business, and displaying an updated equity reward status to the user.

In this way, fractional shares of stock in a business may be distributed to customers in a timely manner based on tracked user loyalty purchases using a loyalty platform, while reducing risk associated with maintaining a large inventory of stock (wherein the risk may include a financial risk associated with holding equity), and while informing users of the status of their pending fractional equity rewards, thereby reducing user frustrations associated with potential reward delays. As an example, by providing the user with an equity reward status, which may comprise a graphical user interface displaying an amount of fractional shares earned as a reward for a user loyalty purchase, along with an estimated reward fulfillment time for the reward, user behavior may be more effectively incentivized via the fractional equity reward, as the equity reward status may be received faster than delivery of the fractional equity reward itself, and thus may more closely couple an incentivized behavior with the incentive for that behavior. As another example, by maintaining merchant deposit accounts on the loyalty platform, wherein the merchant deposit accounts are associated with businesses seeking to reward their customers in fractional shares of equity, the amount of time between the loyalty platform receiving funds from the merchant to purchase a stock reward, and distribution of that reward to the user based on rewardable action may be reduced.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE DRAWINGS

FIG. 1A shows an example of a loyalty platform.

FIG. 1B shows an example of a computing system implementing the loyalty platform.

FIG. 2 shows an example equity allocation system of the loyalty platform.

FIG. 3 shows a high level flowchart of a method for acquiring and distributing fractional shares of stock to users of the loyalty platform.

FIG. 4 shows a high level flowchart of a method for aggregating and liquidating fractional remainders of equity of the loyalty platform.

FIG. 5 shows a high level flowchart of a method for aggregating and executing user fractional equity sell orders.

FIG. 6 shows an example timeline for distributing fractional equity rewards to users of the loyalty platform.

FIG. 7 shows example transactions for acquiring and distributing equity rewards using the loyalty platform.

FIGS. 8-17 show example graphical user interfaces for creating a new account with the loyalty platform.

FIGS. 18-19 show example graphical user interfaces for selecting to receive notifications from the loyalty platform.

FIGS. 20-22 show example graphical user interfaces for linking a payment medium with the loyalty platform.

FIGS. 23-44 show example graphical user interfaces for submitting a brokerage account application.

FIGS. 45-51 show example graphical user interfaces associated with an account login process of the loyalty platform.

FIG. 52 shows a “user agreement” graphical user interface.

FIGS. 53-62 show example graphical user interfaces of the loyalty platform.

FIGS. 63-68 show example graphical user interfaces associated with loyalty selections.

FIGS. 69-70 show example graphical user interfaces for displaying a user's reward portfolio.

FIGS. 71-75 show example graphical user interfaces for placing a fractional equity sell order.

FIGS. 76-77 shows example graphical user interfaces for sending funds from a user account on the loyalty platform to a bank account.

FIGS. 78-89 show example graphical user interfaces for displaying a user's transaction history.

FIGS. 90-98 show example graphical user interfaces for managing a user's linked payment media.

FIG. 99 shows an example graphical user interface for displaying a user's reward portfolio.

### DETAILED DESCRIPTION

The following description relates to systems and methods for a loyalty platform providing fractional equity rewards to users based on tracked user loyalty purchases (the term “user” or “users” is herein used interchangeably with the terms “customer” or “customers”). Examples of a loyalty platform and related features are disclosed in U.S. Provisional Patent Application No. 62/697,284, entitled “DISTRIBUTING SUCCESS-LINKED REWARDS TO CUSTOMERS OF PRIVATELY HELD COMPANIES,” filed on Jul. 12, 2018, and U.S. Provisional Patent Application No. 62/543,884, entitled “DETERMINING EQUITY REWARDS BASED UPON PURCHASE BEHAVIOR”, filed on Aug. 10, 2017. The entire contents of each of the above-identified applications are hereby incorporated by reference for all purposes. The fractional equity rewards may comprise amounts of fractional shares of stock. As used herein, the terms fractional equity rewards, fractional shares of stock, fractional equity, fractional shares, fractions of Exchange Traded Funds (ETFs), fractional amounts of stock, and similar terms shall be used interchangeably, and shall be understood to refer to positive, non-zero, non-integer amounts of shares of stock. For example, the term fractional shares of stock may refer to amounts of stock such as 1.2 shares, 0.00040 shares, 0.017397 shares, 23.7 shares, and irrational amounts of shares of stock such as pi shares, or e shares. In some examples the stock may be publicly traded, while in other examples the stock may be non-publicly traded. The fractional equity reward may be provided to a user by the loyalty platform based on a tracked user loyalty purchase made at a business, wherein the business has a Merchant Agreement with the loyalty platform to provide loyalty customers of said business with rewards of equity on behalf of the business, and wherein a user loyalty purchase may comprise a purchase made by a user at a business to which the user has made a loyalty selection. As an example, the loyalty platform may have an agreement with a business, Coffee Company (a made up business for use as an example, we shall refer to the stock in Coffee Company as CC) to reward loyalty customers of Coffee Company with fractional shares of CC stock based on purchases made by these loyalty customers. The term loyalty customer(s) as used herein (with reference to a business, company, or brand) refers to customers who have made an exclusionary loyalty selection to a brand (in this example, to the Coffee Company), wherein the loyalty selection may exclude the customer from receiving rewards from competing brands (competing brands may comprise brands offering similar products, or brands which operate in a same market, wherein a market is a brand category defined by the loyalty platform). As an example, Coffee Company may reward loyalty customers with fractional shares of CC stock in an amount of 2% of a monetary value of customer purchases. As an example, based on a customer with a loyalty selection to Coffee Company conducting a purchase at Coffee Company with a monetary value of $50.00, that customer may be eligible to receive $1.00 worth of CC stock via the loyalty platform. With a current share price of CC stock being $52.15/share, the loyalty customer in the above example may receive a fractional share of CC in the amount of 0.01917 shares CC.

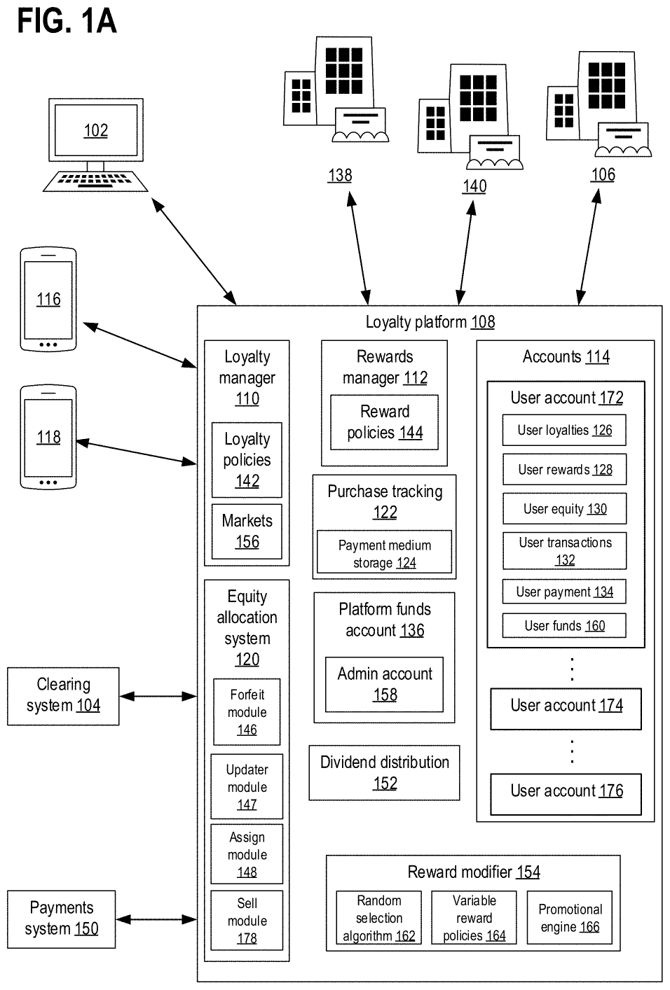

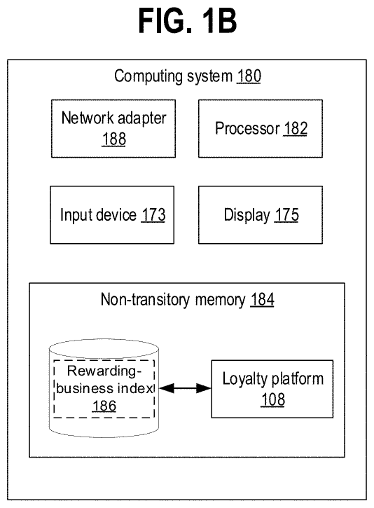

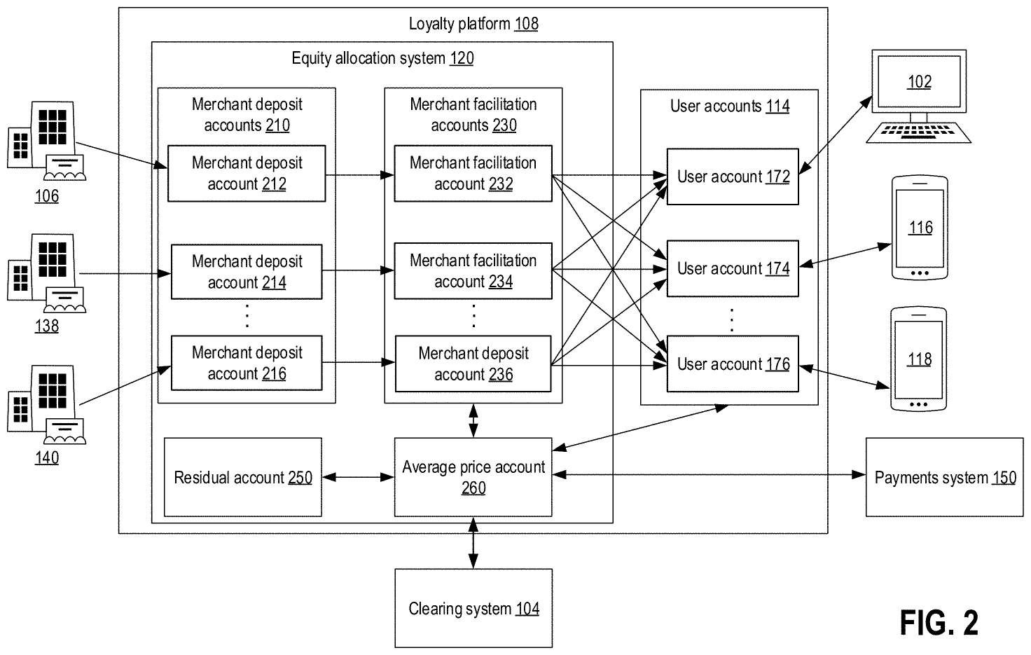

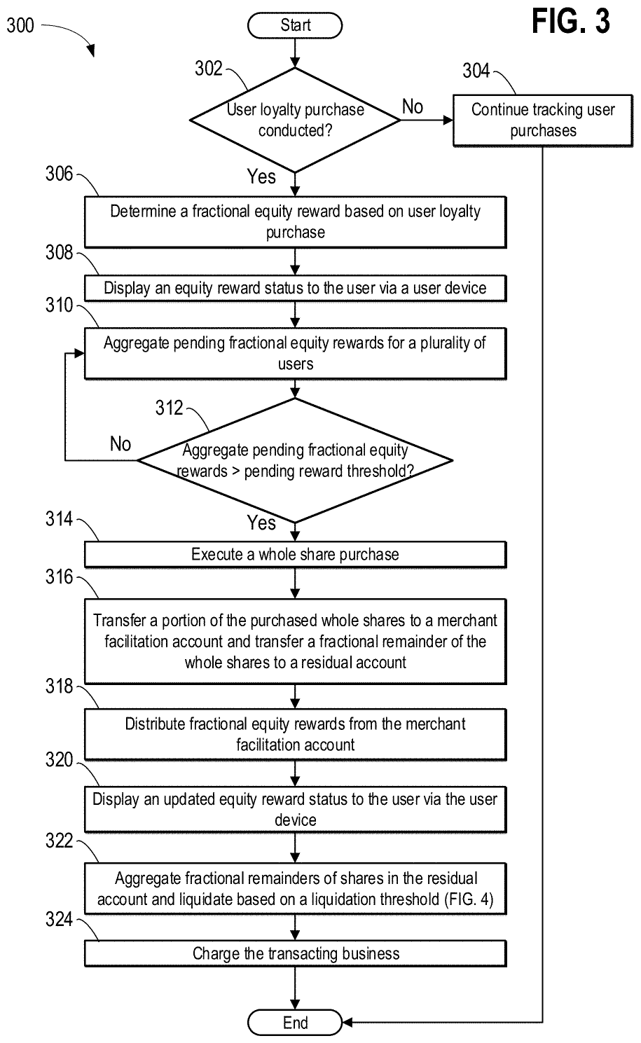

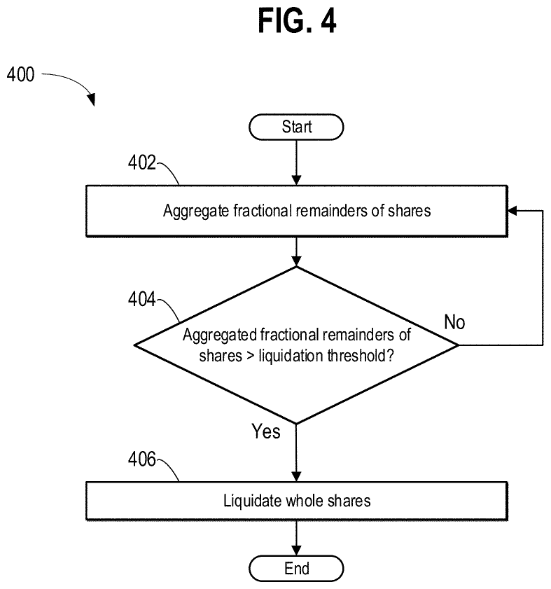

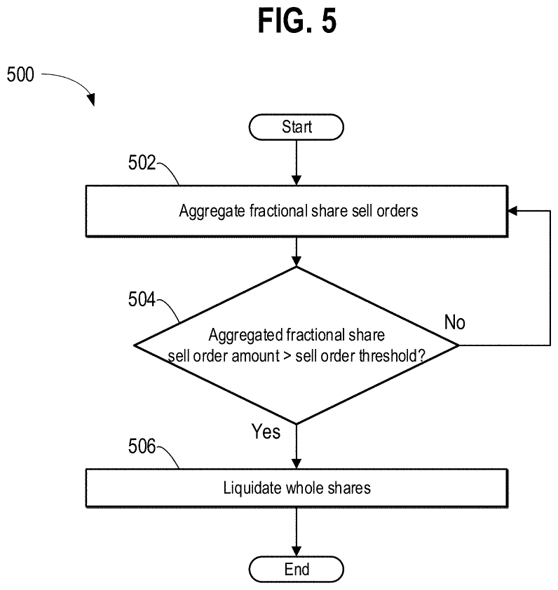

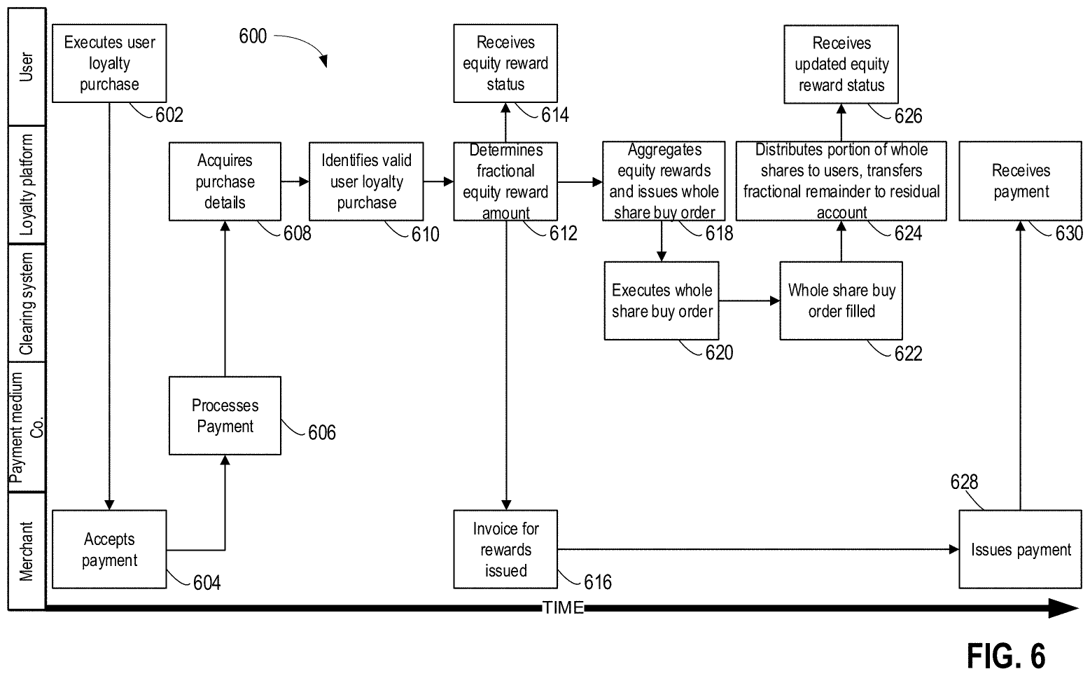

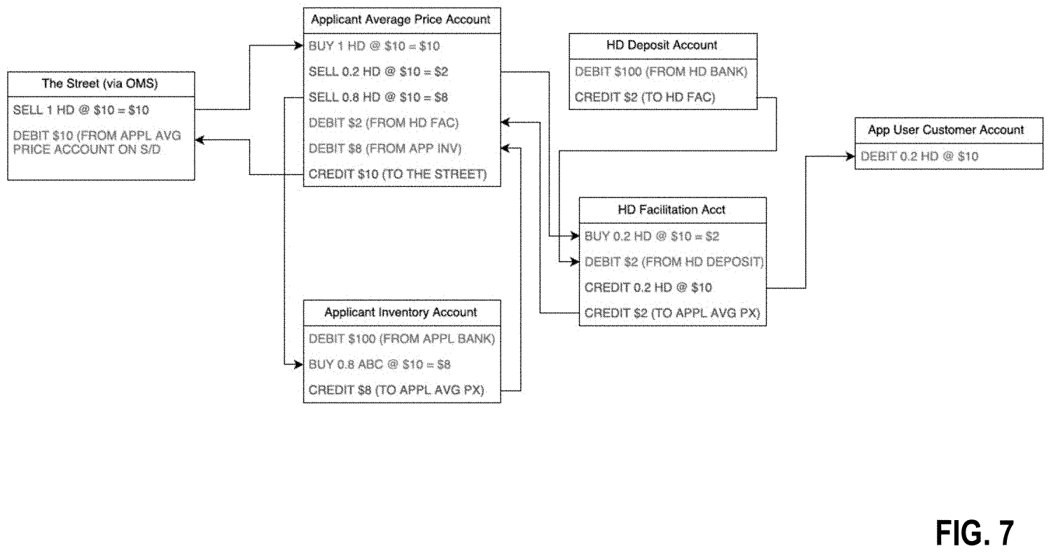

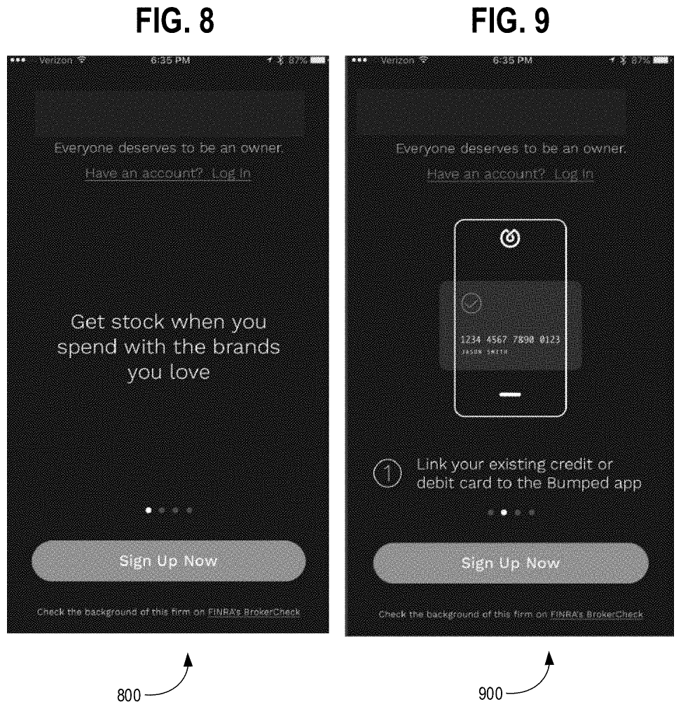

The following description provides examples of systems and methods which may enable a loyalty platform, such as loyalty platform 108 shown in FIG. 1A, to distribute fractional equity rewards to users while reducing a probability of reward distribution delay, reducing an amount of stock held by the loyalty platform, and reducing user frustration by providing equity reward statuses and estimated reward fulfillment times for fractional equity rewards. The loyalty platform may be implemented by one or more computing systems, such as computing system 180 shown in FIG. 1B. Computing system 180 may include non-transitory memory, which may include instructions that when executed carry out one or more steps of one or more of the methods herein disclosed, such as methods 300, 400, 500, and 600 discussed in detail below. It will be understood that loyalty platforms, such as loyalty platform 108, may be implemented by more than one computing system, such as in a distributed computing scheme, wherein various functionalities of the loyalty platform may be enabled by a plurality of networked computing systems working in concert. Loyalty platform 108 may comprise an equity allocation system, such as equity allocation system 120 shown in FIG. 2, which may distribute fractional shares of stock to users based on tracked user loyalty purchases according to a method, such as method 300 shown in FIG. 3. FIG. 4 shows one example of a method by which an equity allocation system of a loyalty platform, such as equity allocation system 120, may liquidate fractional remainders of shares accumulated or aggregated in a residual account of a loyalty platform. Liquidation of aggregated fractional remainders of shares, such as by execution of method 400, may maintain the amount of stock in the residual account below a liquidation threshold, thereby reducing the amount of risk assumed by the loyalty platform. FIG. 5 shows one example method by which an equity allocation system of a loyalty platform may enable users who have earned fractional equity rewards to place sell orders for part, or all, of their accumulated fractional equity rewards. FIG. 6 illustrates an example timeline for distributing fractional shares of equity to users of a loyalty platform using an equity allocation system, while FIG. 7 illustrates one specific example of distributing a fractional equity reward to a user. FIGS. 8-99 illustrate example graphical user interfaces of the loyalty platform, including graphical user interfaces which may be displayed to users by one or more of the systems herein disclosed, or as part of one or more steps of one or more of the methods herein disclosed.

In one example of a method for distributing fractional shares of stock to a user according to the current disclosure, a user of the loyalty platform may make a purchase at a participating business to which the user has made a loyalty selection (such as a business listed in rewarding-business index 186 discussed in detail below) using a linked payment medium (such as a linked payment card). Once the payment settles between a payment card company and the participating business, a fractional share amount needed to satisfy a dollar reward amount is determined by the loyalty platform (for example, based on a 1% reward rate, a $100 purchase made by a user to a participating business may be eligible for a $1 reward of stock in the participating business, thus the dollar reward amount is $1 and the fractional equity reward will be a function of the dollar reward amount and a current market price of the stock to be purchased). Once a fractional share amount is determined for a given purchase, an equity reward status may be displayed to a user, indicating the current status of the pending fractional equity reward, which may comprise the fractional share amount and an estimated reward fulfillment time for the fractional equity reward. The fractional shares of stock to be rewarded to the user, which may herein be referred to as a pending fractional equity reward, may be aggregated with other pending fractional equity rewards earned by other users of the loyalty platform. For one example, pending fractional equity rewards from a plurality of users may be aggregated until the total amount of aggregated pending fractional equity rewards exceeds a pending reward threshold. A whole share buy order may then be entered in an average price account of the loyalty platform based on the aggregated pending fractional equity rewards. For example, if the aggregated pending fractional equity reward is 0.8 shares of stock X, a whole share buy order of the closest whole share amount which is greater than the aggregated pending fractional equity reward may be placed, in this case, a buy order for 1.0 shares of stock X may be placed. Once the buy order is fulfilled through a whole share transaction on the open market (such as through the NYSE), a portion of the whole shares in the average price account may be purchased from the average price account by a merchant facilitation account (in this case, the portion may be the 0.80 shares of stock X owed to the plurality of users).

The portion of the whole shares acquired by the merchant facilitation account may then be distributed or apportioned to the plurality of users in satisfaction of the aggregated pending fractional equity reward. For example, the merchant facilitation account may distribute the acquired 0.8 shares of stock X by allocating 0.5 shares of stock X to user A, and 0.3 shares of stock X to user B, based on user A having a pending fractional equity reward of 0.5 shares of stock X and user B having a pending fractional equity reward of 0.3 shares of stock X. Upon distribution of the fractional equity rewards to the plurality of user accounts associated with the plurality of users, an updated equity reward status may be displayed to the plurality of users, indicating that the pending fractional equity reward has been distributed. Although in the current example the user receives two equity reward statuses, it is within the scope of the disclosure to send any number of equity reward statuses, which may be sent at any time during the process of aggregating, acquiring, and distributing, pending fractional equity rewards. For example, equity reward statuses may be displayed to a user via a display of a user computing device upon determination of an amount of fractional shares to be distributed to said user; a display to the user once the fractional equity reward has been aggregated with other fractional equity rewards; a display to the user upon acquisition of shares of equity by the merchant facilitation account; and a display to the user upon transfer of the pending fractional equity reward to the account of the user. Each of the fractional equity reward statuses may comprise different information and each equity reward status may further contain an updated estimated reward fulfillment time.

The funds used by the merchant facilitation account to buy the portion of the whole shares from the average price account may originate from the merchant deposit account; therefore funds may flow from the merchant deposit account to the open market by passing through the merchant facilitation account and the average price account. A fractional remainder of shares left in the average price account after the portion of shares used to reward users has been purchased by the merchant facilitation account (in this case the fractional remainder of shares is 1.0−0. 8=0.20 shares of stock X) may be purchased by a residual account of the loyalty platform and transferred thereto. Equity acquired by the average price account may be allocated to a merchant facilitation account and residual account within a threshold duration of time, such that the balance of equity within the average price account after a duration may be zero. For example, the process of allocating the portion of the whole shares of stock to the merchant facilitation account and transferring the fractional remainders of shares to the residual account may be completed within 24 hours, such that the average price account does not hold positions in equity for more than a 24 hour period. Whole share remainders of stock in the residual account may be sold on the open market. For example, a whole share remainder of stock in the residual account may be sold upon a total amount of stock within the residual account exceeding a liquidation threshold. In another example, a whole share remainder of stock may be sold periodically, such as after a predetermined duration of time has elapsed. In one example, selling a whole share remainder of stock may occur by placing a sell order from the residual account on the open market. In a another example selling a whole share remainder of stock may occur by transferring the whole share remainder to the average price account and placing a sell order for the whole share remainder on the open market via the average price account. In this way, an amount of stock within a residual account of the loyalty platform may be reduced to below a liquidation threshold, thereby reducing the amount of risk assumed by the loyalty platform. Upon settlement, funds obtained from selling the whole share remainder may replenish the cash balance in the residual account, and may be used to purchase fractional remainders of shares left over after subsequent cycles of fractional equity reward distribution.

The loyalty platform may provide a notice to the participating business indicating an amount of funds needed to replenish a merchant deposit account maintained by and within the loyalty platform on behalf of the participating business. Funds stored within the merchant deposit account of the participating business may be utilized by the loyalty platform on behalf of the participating business to purchase shares of stock to reward customers of the participating business. “Replenish”, as used herein with reference to funds within a merchant deposit account, may refer to maintaining funds within a merchant deposit account above a threshold amount of funds. In one example, a threshold amount of funds to be maintained within a merchant deposit account may be determined as a dollar amount corresponding to ten days' worth of fractional equity rewards for that business, such as may be determined using a rolling average rate of fractional equity reward distribution for a given business. The participating business may, based on the provided notice, direct its bank to transfer via ACH this dollar amount to the merchant deposit account.

FIG. 1A schematically shows an example loyalty platform 108. Loyalty platform 108 may be implemented by one or more computing systems. In one example, loyalty platform 108 may be implemented by a server. In another example, loyalty platform 108 may be implemented by a plurality of computing systems working in concert, such as through a network connection, wherein each of the plurality of computing systems may implement part of the loyalty platform 108. Loyalty platform 108 may be configured to electronically communicate with external computing systems, such as user computing systems 102, 116, and 118, businesses 106, 138, and 140, clearing system 104, and payments system 150. In one example, loyalty platform 108 may be configured to electronically communicate with one or more additional computing systems via a network such as the Internet, wherein the electronic communication may in one example comprise transmission and reception of data between the loyalty platform 108 an one or more additional computing systems.

User computing devices 102, 116, 118, which may interface with loyalty platform 108 via a network connection, may each be associated with at least one user and further associated with at least one user account stored in non-transitory memory of one or more a computing systems implementing loyalty platform 108. As an example, use of the term “user” or “prospective user” or may refer to any legal entity, whether individual or corporate. Each user computing device may be associated with a user and thus enable the user to communicate with loyalty platform 108. In one example, user computing devices 102, 116, 118 may be associated with user accounts 172, 174, 176 and may be any associated corporation or associated individual. Users associated with user computing devices 102, 116, and 118 may register with loyalty platform 108 and make user purchases at a plurality of businesses, such as businesses 138, 140, 106. Based upon user loyalty selections, wherein a loyalty selection may comprise a selection of an exclusionary loyalty to one business in a market, the user may be entitled to a fractional equity reward upon executing a user loyalty purchase (a purchase between a user and a business with which the user has made a loyalty selection). Additionally, the user may be excluded from receiving rewards from unselected businesses based on the loyalty selection. In one example, upon distribution of the fractional equity reward to a user account, such as user account 172 within user accounts 114 on loyalty platform 108, the loyalty platform 108 may transmit an equity reward status via network connection to the user computing device to display information pertaining to a pending fractional equity reward (as used herein, the terms pending fractional equity reward, and pending reward, refer to a fractional share of stock to which a user is entitled based on a user loyalty purchase, but which has not yet been distributed to the user). In one example, an equity reward status, such as that illustrated in FIG. 55, may indicate a current stage or state of reward distribution for a pending fractional equity reward or for a plurality of pending fractional equity rewards. In another example, an equity reward status may include an estimated reward fulfillment time for a pending fractional equity reward, such as an expected date by which the pending fractional equity reward may be distributed to the user account or an estimated duration of time until one or more stages or steps of the reward distribution process are completed (for example, a stage or step of the reward distribution process may comprise one or more of calculating the fractional equity reward, aggregating the fractional equity reward, purchasing the fractional equity reward, and distributing the fractional equity reward to the user account).

User computing devices 102, 116, 118 may each include a processor, memory, communication interface, display, user input devices, GPS/position sensors, and/or other components. In one example, a location of user computing device 116 may be determined via a GPS system associated therewith. In one example, information from loyalty platform 108 may be transmitted to user computing device 118 via a network connection (such as the Internet) between user computing device 118 and loyalty platform 108, for rendering within an interface or display implemented at user computing device 116. The display may be used to present a visual representation of the loyalty platform 108. This visual representation may take the form of a graphical user interface (GUI), examples of which are illustrated in FIGS. 8-99. The communication interface may communicatively couple the loyalty platform 108 with one or more other computing systems, such as the payments system 150, clearing system 104, user computing devices, and/or business computing devices. The communication interface may include wired and/or wireless communication devices compatible with one or more different communication protocols. As non-limiting examples, the communication interface may be configured for communication via a wireless telephone network, or a wired or wireless local- or wide-area network. User input device(s) may comprise one or more user-input devices such as a keyboard, mouse, touch screen, or game controller.

Clearing system 104 may comprise one or more computing devices each including a processor, memory, communication interface, and/or other components. The memory of the computing device(s) of clearing system 104 includes instructions or rules for managing a clearing house for assignment of public shares. As a further example, clearing system 104 may comprise a clearing house for assignment of non-public shares. Clearing system 104 may communicate with equity allocation system 120 of loyalty platform 108 in order to execute transactions such as the buying or selling of shares, or fractional shares, via average price account 260 of the equity allocation system 120.

Payments system 150 may comprise one or more computing devices each including a processor, memory, communication interface, network adapter, user input device(s), and/or other components. The memory of the computing device(s) of payments system 150 includes instructions or rules for disbursing and/or receiving payments via one or more banks, bank accounts, credit card accounts, checking accounts, online payments systems, or virtual wallets. In some examples, payments system 150 may include discrete accounts, each of which may be associated with a user account 172, 174, 176 of accounts 114 on the loyalty platform 108.

Businesses 138, 140, and 106 may be any merchant, business place, brand, bank, financial institution, entrepreneur or entrepreneurial entity associated with loyalty platform 108. As an example, use of the term “business” or “merchant” or “brand” may contemplate any stock corporation, whether private or public. Each business may communicate with loyalty platform 108, for example, via a business computing device. Each user computing device may include a processor, memory storing instructions executable by the processor, display, user input devices, and a communication interface.

Any of the computing devices, modules, or elements described herein with reference to FIG. 1A and FIG. 1B may communicate with each other via a network. For example, loyalty platform 108 may communicate with clearing system 104 and payments system 150 via a network.

Loyalty platform 108 may include a plurality of modules including a loyalty manager 110, rewards manager 112, accounts 114, equity allocation system 120, purchase tracking 122, platform account 136, dividend distribution 152, and reward modifier 154. As illustrated in exemplary FIG. 1B, the various modules of the loyalty platform 108 may include instructions stored in non-transitory memory 184 that are executable by processor 182 of computing system 180. In other examples, the modules may be stored on multiple memories and/or executed by multiple processors distributed across multiple computing devices connected by a network.

Loyalty manager 110 administers loyalty policies 142 and updates user loyalties 126 of accounts 114 with updated loyalty policies relating to businesses to which a user may make a loyalty selection. Loyalty manager 110 includes loyalty policies 142 and markets 156. Markets 156 may be a database or module which may further represent suitable information regarding categorization of businesses affiliated with loyalty platform 108 into discrete markets or business segments wherein the businesses segmented into different markets compete in some way or offer similar products and/or services additionally/alternatively, such information may be stored in rewarding business index 186 shown in FIG. 1B. Loyalty manager 110 may represent suitable information regarding loyalty selections of the loyalty platform 108. As a non-limiting example, loyalty manager 110 may include market definitions for a market such as “Groceries (National).” In some examples, businesses not affiliated and/or businesses pending affiliation or partnership with the platform may be listed in the markets database. In an example, businesses listed in the markets database may have different statuses such as “non-partner” (if not partnered with the platform), “partner” (if partnered with the platform), and “pending partner” (if partnership with the platform is pending). Business statuses in the markets 156 may be useful as they may allow users to be made aware of businesses which may or may not become platform partners over time, which may factor into a user's decision to make a loyalty selection to a particular business in a market. In one example, a “Groceries (National)” market might include large, nation-wide grocery chains, not limited to, for example, COSTCO, ALBERTSON'S, DOLLAR GENERAL, KROGER. In an example, a market may include any number of businesses and there may be any number of markets included in markets 156. In an example, market definitions may be defined by administrators of the platform account 136.

Additionally, loyalty manager 110 may include loyalty policies 142 which may further include instructions or information relating to managing loyalties across markets 156 of loyalty platform 108. Separating businesses into individual markets is not so simple, as many business and/or merchants exist not only in one market, but are diversified and compete in many different markets. For example, a massive big-box store such as WALMART sells not only groceries, but also home goods, including electronics, prescription medications, and clothing. As such, loyalty manager 110 may further include loyalty policies 142 that limit the loyalty selections for a user across different markets, so that a user may only select loyalty to a particular business across different markets (of markets 156) a particular number of times. In an example, a user may be allowed to select loyalty to only one business for a single market. In another example, a user may be allowed to select a first loyalty to a business in a first market and to select a second loyalty to the business in a second market. In a further example, a user may be allowed to select loyalty to a business as many times as allowed by loyalty policies 142 across different markets, if the business is “multi-listed” or offered as a loyalty selection across different markets. In a further example, a user may be allowed to select loyalty to one or more businesses listed within a market.

Further, in some examples, loyalty manager 110 may process loyalty switches of the user. In one example a user may elect to switch-loyalties after receiving a loyalty-review from the loyalty platform. In one example, a “loyalty review” may display to a user a purchase history, along with an indication of which purchases received loyalty rewards, which purchases did not receive loyalty rewards, and which purchases could have received a greater amount of loyalty rewards if a loyalty-switch was made. For example, the loyalty platform may display a “loyalty review” button within a user interface on a display of a user device, upon selection of the “loyalty review” button by the consumer, a purchase history in the grocery category (as used herein, a category of the loyalty platform is equivalent to a market of the loyalty platform) may be displayed in the user interface, wherein the purchase history may indicate that the user was spending 40% (of the total spent in the grocery category of the loyalty platform) over the last 3 months at Kroger, and 60% at Albertson's, but their loyalty is to Kroger. Based on the information displayed to the user by the loyalty review, the user may elect to switch loyalties from Kroger to Albertson's. In one example, the loyalty review may include automatically prompting a user with a loyalty-switch offer upon a determination that the user spends more with a business in a market to which the user is not currently loyal than the user spends with a business to which the user is currently loyal. In response to a user selecting a loyalty switch offer, loyalty manager 110 may update user loyalties associated with an account of a user, such as user loyalties 126 of user account 172.

Rewards manager 112 may be a module or database and may include reward policies 144 which may further include instructions or information comprising rules for providing fractional equity rewards based upon a user's selected loyalty to a transacting business (business with which transaction occurs). Additionally, reward policies 144, in an example, may include specific rule sets regarding equity rewards for a user executing purchases at or with a particular business (herein referred to as business reward policies) to which the user has selected loyalty via the loyalty platform. As an example, a user's long-term loyalty may be rewarded with increased equity rewards. In some examples, equity rewards may increase over time while in other examples, equity rewards may randomly and/or predictably vary over time. In some examples, variable, increasing, and/or long-term loyalty rewards may form stronger user-business relationships and user loyalty. Additionally, if a user switches loyalties from a first company in a first market to a second company in the first market, a promotional “loyalty-switch offer” may be made available to the user. In an example, a “loyalty-switch offer” may comprise a period of increased equity rewards per transaction with the business. For example, a “loyalty-switch offer” might also comprise any of a cash reward, discounted purchases, a set amount of equity, or any other loyalty-switch promotion desired by the administrators of the loyalty platform. As a further example, administrator account 158 or platform account 136 may modify reward policies 144 of rewards manager 112.

Accounts 114 may be a module or database including instructions, information, and/or rules relating to personal and loyalty platform information for each user 102, 116, 118 associated with the loyalty platform 108. As an example, users 102, 116, and 118 may register with loyalty platform 108 via a smartphone, computer, point-of-sale unit at businesses 106, 138, 140, or other network-enabled computing device in order to build and create user accounts 172, 174, 176 associated with (as an example) users 102, 116, and 118, respectively, the accounts being stored in accounts 114. As an example, accounts 114 may include user information for each user, including user loyalties 126, user rewards 128, accumulated user equity 130, user transactions 132, user payments 134 (including, in some examples, payment preferences, methods, or payment media), and user funds 160.

User equity 130 may include equity currently assigned to a user, such as fractional shares of stock. In one example, user equity 130 may comprise a brokerage account maintained by clearing system 104, wherein the clearing system 104 acts as the custodian of individual user equity accounts. Loyalty platform 108 may receive up-to-date information regarding user equity accounts maintained by clearing system 104, enabling the loyalty platform 108 to inform a user of the current amount of accumulated equity. Further, loyalty platform 108 may communicate with clearing system 104 to conduct buys, sells, trades, or other transactions on behalf of the user. In another example, the loyalty platform 108 may maintain an omnibus account with clearing system 104, and the loyalty platform 108 may further create individual brokerage accounts/user equity accounts, such as user equity 130, maintained within the loyalty platform itself. In this example, the loyalty platform may use the omnibus account to purchase allotments of equities, which may then be journaled/distributed to individual user equity accounts to satisfy pending equity rewards.

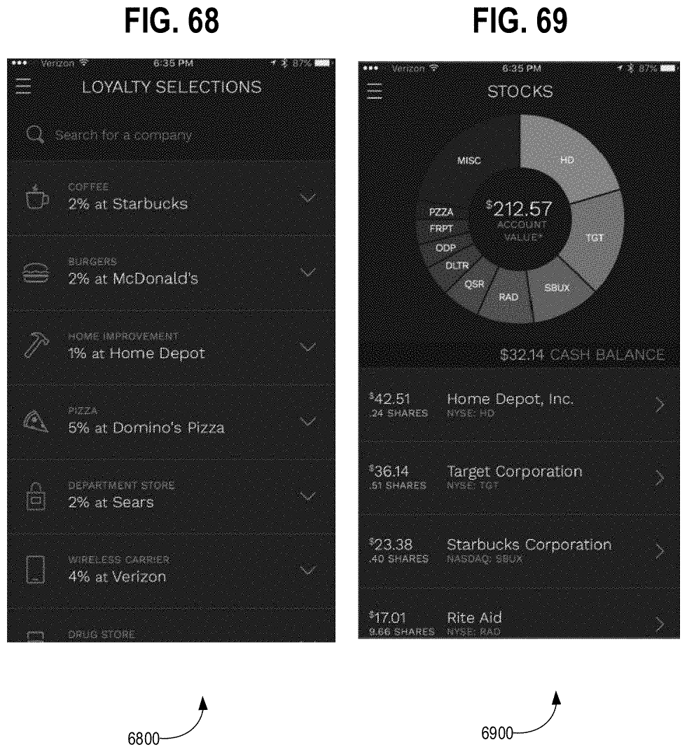

User loyalties 126 may include the businesses and/or brands to which the user has made a loyalty selection in a defined market, and which may be displayed to a user via a graphical user interface, for example, the graphical user interfaces shown in FIG. 68 and/or FIG. 69. User rewards 128 of a user's account may include the rewards for which the user is currently eligible based on user loyalty purchases, such as when making a transaction using payment media registered (or linked) with purchase tracking 122. As used herein, payment media, or a payment medium, may refer to credit cards, debit cards, virtual wallets, or other devices capable of conducting electronic transactions, which are associated with a payment account, such as a checking account. User transactions 132 may include a history of tracked user purchases executed by a user using one or more linked payment media and tracked by loyalty platform 108 via purchase tracking 122. User payment 134 may include user preferences for payment or a virtual wallet held by the loyalty platform 108. User funds 160 may include electronic funds stored for a user which may be used for purchases made via the platform or, as an example, user funds 160 may include funds received via dividend payments from dividend distribution 152. As an example, accounts 114 may be updated continuously, via communication between rewards manager 112, loyalty manager 110, purchase tracking 122, equity allocation system 120, dividend distribution 152 and reward modifier 154, on a schedule, or in response to a trigger in order to keep user account information updated so that a user may be able to receive up-to-date information regarding their account. In an example, purchase tracking 122 may trigger a user account 172 update based upon receiving a notification of a tracked user loyalty purchase and purchase tracking may command rewards manager 112 and loyalty manager 110 to update the user account 172, such as by transmitting an equity reward status to user account 172 based on the tracked user loyalty purchase.

Equity allocation system 120 may manage purchasing, distributing, selling/liquidating, and forfeiting equity as well as updating current share prices. Equity allocation system 120 may include forfeit module 146, updater module 147, assign module 148, and sell module 178, and may be a module or database configured with rules and/or instructions for executing buy, sell, and/or forfeit orders of fractional or whole shares between loyalty platform 108 and clearing system 104 as well as, in some examples, between accounts 114 (including user accounts 172, 174, 176) and platform account 136. Equity allocation system 120 may additionally comprise a plurality of merchant deposit accounts for holding funds used to purchasing equity rewards, a residual account for holding fractional remainders of shares leftover after distribution of fractional equity rewards to the plurality of users is complete, an average price account for conducting street-side whole share purchases and sells, as well as one or more merchant facilitation accounts for temporarily holding fractional equity rewards during fractional equity reward distribution. The merchant deposit accounts, merchant facilitation accounts, residual account, and average price account are not shown in FIG. 1A, but are shown and discussed in detail below, with reference to FIG. 2.

Purchase tracking 122 may be a database or module configured to include instructions and rules configured to track virtual and real-world (e.g., in-store) purchases between users 102, 116, 118 and businesses 138, 140, 106. The purchase tracking system may further include payment medium storage database 124 in order to track purchases for user accounts 172, 174, 176 associated with user computing devices 102, 116, 118 who may execute transactions using payment media which have been registered (linked) and stored at payment medium storage 124. As an example, payment media stored within payment media storage 124 may include any applicable payment methods not limited to credit cards, debit cards, and online payment systems (for example, PAYPAL). In an example, payment medium storage 124 may include registration information relating to credit cards used for transactions between users and businesses. In another example, payment medium storage 124 may include registration information relating to only payments systems used for transaction between users and businesses. In another example, purchase tracking 122 may receive a notification or indication that a user has executed a transaction (for example, purchase or return).

The loyalty platform 108 may include platform account 136, which may comprise an administrator account 158 enabling platform administrators with the ability to make modifications to the loyalty platform 108, for example, adding or removing businesses to the loyalty selections available through loyalty manager 110, modifying rewards options available through rewards manager 112, modifying accounts 114, modifying equity allocation system 120, modifying dividend distribution 152, and varying the rewards provided to users at reward modifier 154.

The loyalty platform 108 may include platform account 136, which may comprise an administrator account 158 enabling platform administrators with the ability to make modifications to the loyalty platform 108, for example, adding or removing businesses to the loyalty selections available through loyalty manager 110, modifying rewards options available through rewards manager 112, modifying accounts 114, modifying equity allocation system 120, modifying dividend distribution 152, and varying the rewards provided to users at reward modifier 154.

Loyalty platform 108 may also include dividend distribution 152 as a database or module comprising instructions or rules which may enable communication with clearing system 104 in order to distribute dividend payments whenever they are set to occur (such as quarterly). Clearing system 104 may, as an example, have information relating to when dividend payments are to be made and how much money or stock per share may paid-out. In one example, if a first business initiates a dividend payment process while a user holds a number of shares of stock in that business, but the user sells the number of shares of stock in the business before the dividend is received by the loyalty platform (such as may occur upon a user selecting to switch loyalty from the first business to a second business), once the dividend is received by the loyalty platform the loyalty platform may offer that dividend to the user as a cash reward (if the dividend comprises cash) or as an equity reward (if the dividend comprises an amount of shares of stock), the loyalty platform may further offer the user an option to redistribute the received dividend. Dividend payments handled by dividend distribution 152 may, in some examples, be sent to user funds 160 in user account 172. In another example, dividend payments handled by dividend distribution 152 may be sent directly to payments 150 via instructions included at user funds 160 to send payment to an account with payments 150 associated with user account 172.

Reward modifier 154 may be a module or database containing instructions configured to provide a reward modification to the normal reward, based upon random selection or based upon one or more actions taken by the user, such as a loyalty switch, accumulating more than a threshold amount of loyalty rewards, or further based one or more policies or promotional events of the rewarding business. As an example, the user may be entitled to a reward, or a normal reward, based upon the user's loyalty selection to a business, and, the normal reward may be modified based upon variable reward policies (discussed herein) to form a modified reward. As explained herein, when a user 102, 116, 118 executes a transaction, the purchase tracking 122 notifies reward modifier 154 of the transaction (which may have been made between a user and business wherein the user had made a loyalty selection to the business of the transaction) and further queries reward modifier 154 to see if the normal reward may receive a modified reward.

Turning now to FIG. 1B, example computing system 180 is shown. Computing system 180 may implement loyalty platform 108 alone, or in combination with other computing systems. In one example, computing system 180 may comprise a server. Computing system 180 includes display 175, input device 173, processor 182, network adapter 188, and non-transitory memory 184.

Display 175 may comprise a monitor, touch screen, projector, or any other device known in the art of computers for enabling a user to observe or sense information rendered by a digital device. Computing system 180 may have stored within non-transitory memory 184 instructions for rendering data, such as loyalty platform 108 data, within a graphical user interface which may be displayed by display 175.

Input device 173 enables a user to interface/interact with computing system 180, and may comprise one or more hardware devices, such as a mouse, keyboard, touch screen, motion tracking camera, or other devices configured to transform user motions, gestures, sounds, or other user actions into an electronic form which may enable a user to input data, or transmit, select, modify, or otherwise interact with data or data structures stored in or displayed by computing system 180.

Processor 182 may include one or more physical devices configured to execute instructions stored in non-transitory memory. For example, processor 182 may be configured to execute instructions that are part of one or more applications, services, programs, routines, libraries, objects, components, data structures, or other logical constructs included in loyalty platform 108.

Network adapter 188 may comprises one or more physical device associated with computing system 180, enabling transmission and reception of data between computing system 180 and one or more additional computing systems. Network adapter 188 may enable computing system 180 to access a local area network, and/or the Internet, and exchange data therewith, such as data which may enable tracking of user purchases and matching between transacting businesses and businesses registered with the loyalty platform (and therefor included in the rewarding-business index).

Non-transitory 184 memory includes one or more physical devices configured to hold data, including instructions executable by the processor to implement the methods and processes described herein. When such methods and processes are implemented, the state of non-transitory memory 184 may be transformed—e.g., to hold different data. The terms “module” and “program” may be used to describe an aspect of the computing system implemented to perform a particular function. The terms “module” and “program” may encompass individual or groups of executable files, data files, libraries, drivers, scripts, database records, etc. Non-transitory memory 184 includes the various files/routines/methods of loyalty platform 108 that when executed by processor 182 perform one or more of the steps herein described with reference to one or more of the disclosed methods. Computing system 180 may optionally include display(s), user input device(s), communication interface(s), and/or other components.

As shown in FIG. 1B, non-transitory memory 184 includes rewarding-business index 186. Rewarding-business index 186 may be stored within non-transitory memory 184 of computing system 180, and may comprise a database or module containing information regarding businesses registered with loyalty platform 108. In one example, rewarding-business index 186 may be used by computing system 180 in conjunction with purchase tracking 122 to quickly determine if a user purchase executed at a business is eligible for a fractional equity reward by matching a description of the transacting business, obtained by purchase tracking 122, with a description stored in rewarding-business index 186 associated with a business offering fractional equity rewards to loyalty users through loyalty platform 108.

In some examples, computing system 180 may be configured to implement a neural network or other machine learning algorithm, wherein the neural network comprises a classifier type neural network, configured to receive as input one or more details of a user transaction/purchase (also referred to as a transacting business description) and to use said input to produce as output a probability rank for one or more, or each, of the businesses stored within rewarding business index 186, wherein the probability rank indicates for a given business, the probability that the purchase occurred with said business. In other examples, computing system 180 may be configured to execute one or more machine learning algorithms capable of learning a non-linear mapping from a feature space comprising purchase details, to an output space comprising business classification scores/probabilities, wherein the learning algorithms may have access to rewarding business index 186, which includes an up to date listing of all businesses partnered with the loyalty platform.

To facilitate accurate matching between a transacting business and its associated reward program/policies implemented by loyalty platform 108, rewarding-business index 186 may include various features or pieces of data relating to the businesses listed therein. In one example, rewarding-business index 186 comprises a database with each entry therein corresponding to a unique business, wherein said entry may comprise a name/title, a link to the reward/loyalty policies established by the business, the status of the reward program associated with that business (such as “active”, “cancelled”, “pending deposit of funds”, etc.).

In one example, a business interested in offering equity rewards via loyalty platform 108 to customers to incentivize greater customer loyalty may register their business with loyalty platform 108. The registration process for businesses may include inputting information relating to the business into loyalty platform 108 and this information may be stored in non-transitory memory of computing systems implementing loyalty platform 108. In one example, business information may be stored in rewarding-business index 186 of one or more computing systems implementing the loyalty platform 108, such as computing system 180. As an example, the business information input into the rewarding-business index as part of the business registration process may include a description of the business, business payment information, business contact information, business locations/addresses, business hours of operation, markets in which the business operates (which may also be stored in markets 156), business reward policies/loyalty policies defining how a fractional equity reward is determined based on tracked user loyalty purchases (which may also be stored in one or more additional locations of loyalty platform 108, such as in loyalty policies 142, and reward policies 144), and other information which may enable the loyalty platform 108 to uniquely identify the business and operate a customer loyalty program customized for that individual business. In one example, a link to loyalty policies and/or reward policies associated with a business registered with the loyalty platform 108 may be included in an entry in rewarding-business index 186. In one example, rewarding business index 186 may contain an equation or algorithm (or a link pointing to a location in non-transitory memory wherein the equation or algorithm is stored) for determining an amount of fractional shares of stock to be allotted to a user based on a tracked user loyalty purchase conducted using a linked payment medium.

Further, rewarding-business index 186 may include product data regarding one or more products offered by one or more brands, wherein the product data may be used to match a tracked user loyalty purchase with a brand or business providing rewards through loyalty platform 108. In one example, product data may include product codes/identifiers for one or more products belonging to a brand. In a more specific example, rewarding-business index 186 may include a catalogue/database of products and product identifiers provided by one or more brands operating a loyalty program through loyalty platform 108, wherein the catalogue/database may include stock keeping unit codes (SKUs) enabling unique identification for one or more products provided by one or more brands registered with loyalty platform 108. In one example, a user may conduct a purchase with a business, wherein the business sells products from a plurality of brands, and upon execution of the purchase, the business may transmit POS data regarding the transaction to the loyalty platform, wherein the POS data may include SKU level detail regarding each of the purchased products. The loyalty platform may match the one or more purchased products with one or more brands using rewarding-business index 186 by correlating the SKU codes included within the POS data to SKU codes included in rewarding-business index 186. In one example, the rewarding business index comprises a list of product identifiers for each brand/business included therein, and upon matching an SKU code included in POS data transmitted to the loyalty platform 108 from a business with an SKU code listed under a first brand in the rewarding-business index 186 the loyalty platform 108 may determine that the user is eligible to receive a reward from the first brand. The loyalty platform 108 may, in response to matching one or more brands using the POS data, reward the user based on the reward policies of the reward programs provided by the one or more brands, and further based on the price of the one or more products purchased from the one or more brands. In another example, upon execution of a transaction between a user and a business, the business may determine which brands correspond to the one or more purchased products, and may transmit the indicated brands to the loyalty platform 108. In this way, the loyalty platform may reward a user with rewards from a plurality of brands/businesses based on a single purchase, by resolving a purchase using data of each purchased product. In some examples, based on a user purchase with a business, wherein the purchase comprises a purchase for a product from a brand, wherein both the business and the brand provide rewards through the loyalty platform, and wherein the user has an active loyalty selection to both the business and the brand, the user may receive rewards from both the business and the brand through the loyalty platform.

A business or brand listed in rewarding-business index 186 may be removed, deleted, or overwritten, upon suspension or cancellation of the equity rewards program established for that business. In another example, upon cancellation or suspension of a customer loyalty program offered by a business, a flag may be set in the entry corresponding to that business in the rewarding-business index, thereby indicating that no equity rewards may be earned based on tracked user loyalty purchases at this business at this time, thus retaining business information within the rewarding-business index and bypassing the need to re-enter information relating to said business into the rewarding-business index in the event that the customer loyalty program associated with the business is resumed at a later time.

Rewarding-business index 186 may be stored in a location of non-transitory memory 184 of computing system 180 and information stored therein may be accessed by computing system 180 upon execution by processor 182 of one or more methods stored in loyalty platform 108, some examples of which are described herein. In one example, rewarding-business index 186 may be accessed by purchase tracking 122 of loyalty platform 108 to attempt to match/correlate a description of a business with which a user recently made a purchase (herein also referred to as a transacting business description) with a description stored in rewarding-business index 186. The transacting business description, comprising data pertaining to the transacting business, may be obtained by loyalty platform 108 via a linked payment medium used to conduct the purchase, or alternatively, through a point of sale device of the transacting business which is configured to transmit purchase details to the loyalty platform, or from a third party purchase data aggregator. If the transacting business description matches a description of a business stored in rewarding-business index 186, the user may be entitled to a fractional equity reward for the tracked user loyalty purchase and one or more additional actions may be taken, such as look-up of the reward policies linked with the rewarding business. The link may be stored in rewarding business-index 186 in a location associated with the rewarding business description, the link may point to a location of non-transitory memory 184 associated with reward policies 144. Thus, rewarding-business index 186 enables computing system 180 to automatically determine if a tracked user purchase is eligible to receive a reward or may be eligible to receive a reward (such as upon a user accepting a loyalty-switch offer) without requiring the user to submit proof-of-purchase information, or perform other potentially annoying tasks employed by conventional rewards programs.

In this way, rewarding-business index 186 may enable loyalty platform 108 to rapidly and automatically determine if a tracked user purchase is in fact a tracked user loyalty purchase and is therefore eligible to receive a fractional equity reward. This may reduce the time between when a user executes a user loyalty purchase and when a fractional equity reward based on that purchase is distributed to the user compared to conventional approaches which require a user to manually input a code or other proof-of-purchase/proof-of-reward. Additional features of the disclosure which may further enable increased speed of fractional equity reward distribution, as well as further enable increased liquidity in the fractional equity rewards once distributed, are discussed below with reference to FIG. 2 and the equity allocation system 120 therein.

FIG. 2 shows equity allocation system 120, which represents one exemplary embodiment of a system for acquiring, aggregating, distributing, liquidating, and otherwise managing fractional equity rewards on a loyalty platform, such as loyalty platform 108. Elements of FIG. 2 which were previously illustrated and described above shall retain their numbering in FIG. 2. Although the accounts within equity allocation system 120, as discussed herein, are included within loyalty platform 108, it will be appreciated that such accounts may be held or maintained by a third party without departing from the scope of the current disclosure. In one example, the accounts discussed with reference to FIG. 2 may be maintained by a brokerage firm on behalf of a loyalty platform. In another example, the loyalty platform may operate and/or maintain the accounts discussed with reference to FIG. 2. In the case that the accounts within equity allocation system 120 are operated by a third party brokerage firm, equity allocation system 120 may electronically communicate with one or more of the accounts via a network to enable one or more of the steps or actions described herein with reference to said accounts.

The accounts discussed with reference to FIG. 2 may comprise instructions stored in non-transitory memory of a computing system, such as a computing system implementing loyalty platform 108, wherein the instructions enable the accounts to hold, trade, buy, and sell securities. In one example the securities may comprise shares of stock in a business. In another example the securities may comprise other kinds of securities, such as one or more of government bonds, municipal bonds, Exchange Traded Funds (ETFs), mutual funds, futures options, and stock options. In another example, the accounts discussed with reference to FIG. 2 may be configured to buy, sell, trade, hold, or otherwise interact with, digital assets, such as cryptocurrency, tokens, smart contracts, etc. In one example, the accounts discussed with reference to FIG. 2, such as average price account 260 may be configured to hold, trade, buy and sell shares of stock in publicly traded businesses. The accounts discussed with reference to FIG. 2 may also be configured to send and receive funds (fiat currency, such as USD) to one or more other accounts, such as, but not limited to, other accounts discussed with reference to FIG. 2. In one example, merchant facilitation account 232 may send an amount of USD to the average price account 260 in exchange for an amount of a security, such as a share of stock. Equity allocation system 120 is shown accompanied by various interacting systems, such as user computing systems 102, 116, and 118, businesses 106, 138, and 140, clearing system 104, and payments system 150. Equity allocation system 120 may alone, on in conjunction with other systems herein described, perform one or more steps of methods 300, 400, 500, and 600 herein disclosed. Equity allocation system 120 comprises merchant deposit accounts 210, merchant facilitation accounts 230, residual account 250, and average price account 260.

Merchant deposit accounts 210 may comprise a plurality of merchant deposit accounts, each corresponding to a unique business. As depicted in FIG. 2, merchant deposit accounts 210 comprise merchant deposit account 212, merchant deposit account 214, and merchant deposit account 216, which are associated with business 106, business 138, and business 140, respectively. Although FIG. 2 depicts three merchant deposit accounts, the current disclosure will be understood to provide for any number of merchant deposit accounts, each associated uniquely with a business, to facilitate the distribution of fractional equity rewards on behalf of the business. As part of a Merchant Agreement between the loyalty platform and a business seeking to provide fractional equity rewards to loyalty customers via the loyalty platform, a business may agree to maintain a minimum balance of funds within the merchant deposit account associated with that business. The funds within a merchant deposit account may comprise fiat currency, such as USD, or other stable, and highly liquid currencies which may be used to purchase shares of stock. It will be appreciated that the minimum amount of funds to be maintained in each of the plurality of merchant deposit accounts 210 may be determined on a business by business basis and, as such, may be different for each merchant deposit account.

In one example, the minimum balance of funds for a merchant deposit account associated with a business may increase as a running average rate of fractional equity reward distribution for that business increases. For example, if the total amount of fractional equity rewards earned per day by loyalty customers of business A doubles, the minimum amount of funds to be maintained in the merchant deposit account associated with business A may also double. In another example, the minimum amount of funds to be maintained in a merchant deposit account of a business may be based on a predetermined threshold, wherein the threshold is equal to the minimum amount of funds. As another example, a threshold defining the minimum amount of funds to be maintained by a business in an associated merchant deposit account may be determined as a total monetary value of all fractional equity rewards distributed to users on behalf of that business over the previous 10 days. As another example, the methods for determining the minimum amount of funds to be maintained in a merchant deposit account associated with a business and used to provide fractional equity rewards to users on behalf of that business may be adjusted based on an upcoming event, such as a sale, a promotional offer, a holiday (such as black Friday, Christmas, etc.), or other foreseeable future events which may influence the amount of fractional equity rewards earned by users.

By maintaining a minimum amount of funds within each of the plurality of merchant deposit accounts 210, a probability of interruption/delay in the distribution of fractional equity rewards to users, such as may occur if the balance of a merchant deposit account reaches zero, is reduced. Further, by basing the minimum amount of funds to be maintained in each of the merchant deposit accounts on an individual business basis and on a running average rate of fractional equity reward distribution for each business, a balance may be struck between minimizing the amount of capital a business needs to commit for a reward program and reducing the probability that a fractional equity reward earned by a user may be delayed.

Each of the plurality of merchant deposit accounts in merchant deposit accounts 210 may be uniquely associated with a merchant facilitation account stored in merchant facilitation accounts 230. Said another way, there may be a one-to-one correspondence between each business using the loyalty platform, each merchant deposit account and each merchant facilitation account. For example, merchant deposit account 212, associated with business 106, may also be associated with merchant facilitation account 232, and may transfer funds to merchant facilitation account 232 to enable the purchase of shares of stock for use as fractional equity rewards for loyalty customers of business 106. Merchant facilitation accounts 230 comprise merchant facilitation account 232, merchant facilitation account 234 (associated with merchant deposit account 214 and business 138), and merchant facilitation account 236 (associated with merchant deposit account 216 and business 140).

Although FIG. 2 shows three merchant facilitation accounts within merchant facilitation accounts 230, it will be appreciated that there may be any number of merchant facilitation accounts stored within merchant facilitation accounts 230. Merchant facilitation accounts 230 may comprise brokerage accounts and thus may be configured to hold both fiat currency and equity. Each of the merchant facilitation accounts stored within merchant facilitation accounts 230 may be configured to communicate with other modules, systems, or components of loyalty platform 108. For example, merchant facilitation accounts 230 may have access to each of the user accounts stored within user accounts 114, which may enable merchant facilitation account to calculate aggregate pending fractional equity rewards owed to these user accounts by one or more of the plurality of merchant facilitation accounts within merchant facilitation accounts 230. In another example, the calculation of pending fractional equity rewards associated with each of the plurality of merchant facilitation accounts may be determined on a per account basis; that is, each of the merchant facilitation accounts may perform an independent calculation of the amount of pending fractional equity rewards it may satisfy. Merchant facilitation accounts 230 may also communicate, that is send and receive data, with merchant deposit accounts 210. In one example, based upon a determination by a merchant facilitation account within merchant facilitation accounts 230, an amount of aggregate pending fractional equity rewards owed by that account to one or more of a plurality of users is greater than a threshold amount, a request may be sent by the merchant facilitation account to an associated merchant deposit account, requesting a transfer of an amount of funds to meet, or reduce below the threshold, the amount of aggregate pending fractional equity rewards.

Each of the merchant facilitation accounts within merchant facilitation accounts 230 may be configured to send and receive funds and shares of stock. For example, each account within merchant facilitation accounts 230 may be configured to receive funds from merchant deposit accounts 210, transfer funds to the average price account 260, receive shares of stock from the average price account 260, and distribute the received shares of stock amongst a plurality of user accounts. As a specific example, $500 may be transferred from merchant deposit account 214 to merchant facilitation account 234 (by loyalty platform 108 on behalf of business 138), which may then be transferred to the average price account 260 in exchange for $500 worth of equity (purchased by the average price account 260 from an exchange, such as the NYSE). Once the $500 worth of equity is received by merchant facilitation account 234, it may be distributed by merchant facilitation account 234 to a plurality of user accounts stored within user accounts 114, to satisfy pending fractional equity rewards. The $500 worth of equity may comprise an amount of fractional shares of stock or may be a number of whole shares of stock. In the case that the $500 worth of equity comprises a fractional amount of shares of stock, the average price account 260 may round-up the fractional amount of shares of stock to the nearest whole share to enable the buy-order to be executed by a conventional exchange. For example, if the $500 equates to 9.6 shares of stock, the average price account may round-up the 9.6 shares to 10.0 shares, with the 9.6 shares being transferred to merchant facilitation account 234 and the fractional remainder share of 0.4 being transferred from the average price account 260 to residual account 250. The 9.6 shares (the portion of the whole shares purchased by the average price account 260 using funds received from merchant facilitation account 234) may then be distributed to a plurality of user accounts, such as user account 172, user account 174, and user account 176, to satisfy pending fractional equity rewards associated with those accounts.

Average price account 260 may be configured to conduct whole share buys and sells via clearing system 104. In one example, clearing system 104 may comprise a computing system with instructions for executing buy and sell orders for securities on an open market, such as the NYSE. Average price account 260 may be configured to send and receive both funds and securities to/from one or more of the other accounts discussed with reference to FIG. 2. Average price account 260 may comprise instructions stored in non-transitory memory of a computing system to perform one or more of the functions/steps/methods discussed herein. In one example, average price account 260 may comprise instructions to allocate purchased whole shares of stock within a duration of time from the time of purchase, thereby reducing the balance for a given equity to zero by a pre-determined duration from the time of purchase. In one example the duration of time may be 24 hours. In another example, the duration of time may be 6 hours. In another example, the average price account may comprise instructions to allocate the entirety of acquired/purchased whole shares of stock by a pre-determined time. For example, average price account 260 may be configured with instructions to allocate the entirety of its securities to other accounts of the loyalty platform and/or equity allocation system 120 by market close each day, such that securities are not held by average price account 260 overnight.

Residual account 250 may purchase fractional remainders of shares from average price account 260 leftover after a first portion of whole shares purchased by the average price account is used to satisfy pending fractional equity rewards, such that the average price account does not hold positions in a security for longer than a duration, wherein the duration may be based on regulatory rules or may actively adjusted to reduce penalties or risk associated with holding securities such as stock. In one example, within a 24 hour period of the average price account 260 executing a whole share purchase via clearing system 104, a first portion of the purchased whole shares (which may comprise a fractional amount of shares) may be transferred to one of the accounts within merchant facilitation accounts 114 (for distribution to users) and a fractional remainder of shares, equal to the difference between the purchased whole shares and the transferred portion of shares may be purchased by the residual account. In this way, all shares purchased by the average price account 260 may be transferred to other accounts within a duration of time, such that after the duration, the balance of the average price account 260 for the purchased whole shares is zero.

A monetary expense of the fractional remainder of shares purchased by residual account 250 may be debited from residual account 250 and credited to average price account 260 in exchange for the fractional remainder of shares. The fractional remainder of shares transferred to the residual account may generally be less than a single share of stock, which may not be easily sold on conventional markets. The inventors herein have recognized this and have provided approaches which may enable rapid and efficient liquidation/exchange of fractional shares of stock. As an example, the residual account 250 may aggregate fractional remainders of shares from multiple cycles of fractional equity reward distribution, such that over time, the amount of fractional remainders of shares may exceed a liquidation threshold and a whole number of shares may be sold by residual account 250. The liquidation threshold may in one example comprise a single share, such that upon exceeding the liquidation threshold a single whole share of equity may be sold via clearing system 104. The liquidation threshold may comprise any positive non-zero amount of equity and may comprise fractional or whole numbers of shares. For example, a liquidation threshold for a stock may comprise 1.0 shares, but may alternatively comprise 5.23 shares, 100.1 shares, 3 shares, etc. As a plurality of different stocks may be used for fractional equity rewards, residual account 260 may accumulate a plurality of different types of stock and each may have an associated liquidation threshold, wherein each liquidation threshold may be determined for the individual stock, such that a plurality of liquidation thresholds corresponding to the plurality of different stock types may be used.

Upon exceeding the liquidation threshold, the loyalty platform 108 may determine an amount of whole shares of stock to for which to place a sell order. The amount of whole shares to be sold may be unique for each stock and may depend on the liquidation threshold. For example, a upon an aggregated amount of fractional remainders of stock, for a given stock, in the residual account 250 exceeding a liquidation threshold of 1.0 shares, a whole share sell order in the amount of 1.0 shares of stock may be placed, either by residual account 250, or by the average price account 260 on behalf of the residual account 250. In another example, upon the aggregated fractional remainders of shares of stock, for a given stock, exceeding a liquidation threshold of 10.5 shares of stock, a whole share sell order in the amount of 2.0 shares of stock may be placed. The whole share sell order of the aggregated fractional remainders of shares may be executed via the average price account 260, such that the amount of whole shares aggregated by the residual account 250 are transferred to average price account 260 and then sold via clearing system 104 on the open market. Alternatively, the whole share sell order may be executed directly by residual account 250. Upon fulfillment of the sell order for the amount of whole shares, funds in exchange for the whole shares may be transferred to residual account 250 and used in subsequent cycles of reward distribution to purchase additional fractional remainders of shares of stock. In this way, funds in the residual account 250 may change slowly over time, such that an initial amount of funds placed in the residual account 250 for purchasing fractional remainders of shares may require replenishment with reduced frequency compared to alternative approaches.

Turning to FIG. 3, an example method 300 for distributing fractional equity rewards is shown. Method 300 may enable faster distribution of fractional equity rewards to users compared to conventional methods. For example, by using funds in a merchant deposit account of the loyalty platform for acquisition of whole shares of stock to satisfy the pending fractional equity rewards, a delay of reward distribution which may occur when transferring funds from a merchant bank account may be avoided. In another example, by aggregating pending fractional equity rewards of the plurality of users and executing a whole share purchase based on the aggregated pending fractional equity rewards surpassing a pending reward threshold, an amount of stock left over from the whole share purchase (that is, not distributed to a user as a reward) may be reduced, thereby reducing the amount of stock held by the loyalty platform and reducing a risk assumed by the loyalty platform. Additionally, by indicating to users the progress/current stage of their pending fractional equity rewards, such as by indicating to a user when a transaction entitles that user to a reward, indicating that the process of reward distribution has been initiated, and indicating when the reward has actually been distributed to their account, user impatience may be reduced. Method 300 may be stored in non-transitory memory of a computing system implementing a loyalty platform, such as computing system 180, and one or more, or all, of the steps of method 300 may be automatically executed by the loyalty platform, or by one or more subcomponents, modules, databases, or subsystems of the loyalty platform.

Method 300 begins at 302, wherein a loyalty platform, such as loyalty platform 108, may determine if a user loyalty purchase has been conducted. A user loyalty purchase may comprise a transaction in which a user, with an account on a loyalty platform and a loyalty selection to a first business, exchanges currency with the first business in exchange for goods or services, wherein the first business is registered with the loyalty platform and provides fractional equity rewards to loyalty customers there through. The first business may be included in a database of the loyalty platform, such as rewarding business index 186, and this database may be used to correlate information obtained regarding a user purchase with a business registered with the loyalty platform and actively offering equity rewards there through.

In one example, the loyalty platform may obtain details of a user purchase through a third party data aggregator, or alternatively the loyalty platform itself may receive details of a user loyalty purchase via payment media account information provided to the loyalty platform by the user, such as during a user account creation process. The loyalty platform may then correlate purchase details with a database of registered businesses to ascertain if the user purchase was conducted with a business offering fractional equity rewards through said loyalty platform. The process of correlation may comprise inputting purchase details acquired for a given transaction into a neural network trained to match a set of purchase details with a unique business within a database of the loyalty platform. In another example, the neural network may output a confidence score for said matching, such that for a given transaction, a confidence score associated with the most likely business may be output. A confidence threshold for business matching may be employed, such that above a confidence level, the process of reward distribution may proceed, and below the confidence threshold, no reward may be earned. In another example, a confidence rating below a confidence threshold may trigger a manual review process for a given transaction, wherein the details of the tracked purchase may be displayed for manual evaluation, and a determination of if a user loyalty purchase occurred may be made.

The loyalty platform may further ascertain which customer account is associated with the tracked user purchase and may subsequently determine if said user account has an active loyalty selection to the business with which the user conducted their purchase. If the business is registered with the loyalty platform and the user account associated with the purchase includes a loyalty selection to the business, the tracked user purchase is determined to be a tracked user loyalty purchase, and is therefore eligible for a fractional equity reward. However, if at 302 it is determined that no user loyalty purchase has been conducted, method 300 may proceed to 304, which includes the loyalty platform continuing to track/monitor user purchases. Method 300 may then end. However, if at 302 it was determined that a user loyalty purchase has occurred, method 300 may proceed to 306.

At 306, method 300 includes determining a fractional equity reward based on user loyalty purchase. The determination of a fractional equity reward may be based on a monetary value of the user loyalty purchase, reward policies of the business with which the purchase was conducted, and may further be based on a transaction history or loyalty history of the user who conducted the loyalty purchase. As an example, based on a user loyalty purchase with a monetary value of $150 and further based on the reward policies of the business with which said purchase was conducted comprising a reward rate of 2%, the user may be eligible for $3 worth of a fractional equity in stock Y (the USD equivalent of a reward to be distributed in the form of equity may be herein referred to as a dollar reward amount). Step 306 of method 300 may further include calculating the amount of fractional shares to distribute to the user based on the dollar reward amount and further based on a current market price of the stock to be rewarded. Continuing with the above example, based on the $3 reward of stock Y to be distributed to the user, and further based on a $30/share price for the stock to be rewarded to the user, it may be determined at step 306 that the user is to receive 0.100 shares of stock Y. Upon determining the fractional equity reward to be distributed to a user (herein also referred to as a pending fractional equity reward), method 300 may then proceed to 308. The reward amount and corresponding fractional reward may be rounded up or down to the prescribed number of decimal places. For example, a $3.24 purchase at a 2% reward yields $0.0648. That may be rounded to $0.07 or rounded down to $0.06 at the discretion of the loyalty platform. Alternatively, at 306, the business with which the user loyalty purchase was conducted may transmit a dollar amount to the loyalty platform to reward a user. The business may further transmit an indication of one or businesses/brands for which the dollar amount is to be used to purchase equity in.

At 308, method 300 includes displaying an equity reward status to the user. The equity reward status may be rendered on a display of a computing device associated with the user account to receive the pending fractional equity reward. In one example, the equity reward status may comprise one or more of a push notifications, email, or other electronic communications. In one example, the equity reward status may indicate the amount of fractional shares of stock to be distributed to a user, the title of the purchase for which the reward was earned, and an estimated reward fulfillment time of the reward. The amount of the pending fractional equity reward may be determined as indicated above, with reference to step 306, while the estimated reward fulfillment time may be based on one or more parameters associated with the fractional equity reward distribution process. As an example, the estimated reward fulfillment time may be based on one or more of the current amount of pending fractional equity rewards, a rolling average fulfillment time for previously distributed rewards, a current rate of pending fractional equity reward aggregation, and an amount of funds held within the merchant deposit account associated with the current pending fractional equity reward. For example, an estimated reward fulfillment time may be fine-tuned by adjusting a rolling average fulfillment time with a current rate of aggregation for pending fractional equity rewards in the same stock as the current reward. In the case that the rate of aggregation is above a baseline level, such as when a current rate of aggregation is above a running average rate of aggregation, the running average rate of fulfillment time may be decreased to produce the estimated fulfillment, which may be displayed via a display of a user computing device. It will be appreciated that, although method 300 includes displaying a first equity reward status and an updated equity reward status, any positive integer number of equity reward statuses may be displayed to a user computing device to enable updates regarding the pending fractional equity reward based on any number of steps or events occurring during the fractional equity reward distribution process. Upon displaying the equity reward status method 300 may then proceed to 310.

At 310, method 300 includes aggregating pending fractional equity rewards for a plurality of users to form an aggregate pending equity reward. In one example, the pending fractional equity rewards may be aggregated by a merchant facilitation account which may be responsible for satisfying said rewards. The amount of aggregated pending fractional equity rewards may be communicated by the merchant facilitation account to the merchant deposit account and the average price account of the loyalty platform. Aggregation may comprise a numerical addition of a new pending fractional equity reward to a previously aggregated (and unsatisfied) amount of pending fractional equity rewards. The aggregated pending fractional equity rewards may be stored in non-transitory memory of a computing system associated with the loyalty platform and may be accessed by one or more of the accounts within an equity allocation system of the loyalty platform. Method 300 may then proceed to 312.

At 312, method 300 includes evaluating if aggregated pending fractional equity rewards exceed a pending reward threshold. The pending reward threshold may be chosen to limit or reduce the fractional remainder of stock left over after purchasing a whole number of shares and distributing a portion of those shares to users to satisfy the pending fractional equity rewards (each cycle of pending reward aggregation, reward purchase, and reward distribution may be herein referred to as a reward distribution cycle). For example, the pending reward threshold may be chosen such that the amount of aggregated pending fractional equity rewards is within a threshold of a nearest whole number of shares. In a specific example, a pending reward threshold of 0.8 shares of stock X may be chosen in order to reduce the fractional remainder of shares left over after 1.0 shares of stock X is purchased, and a 0.80 shares of stock X is taken from the purchased 1.0 shares to satisfy pending fractional equity rewards, thereby limiting the amount of fractional remainders of shares to 0.20 shares of stock X or less. If the loyalty platform determines that the aggregated pending fractional equity rewards do not exceed a pending reward threshold, method 300 may return to 310 and continue aggregating pending fractional equity rewards until the amount of aggregated rewards exceeds the pending reward threshold. The pending reward threshold enables control over the amount of stock held within the residual account of the loyalty platform and may thereby control the amount of capital held within the residual account to enable the reward distribution process. However, if at 312 the loyalty platform determines that the pending fractional equity rewards exceed the pending reward threshold, method 300 may proceed to 314.

At 314, method 300 includes executing a whole share purchase based on the amount of aggregated pending fractional equity rewards. For example, based on the amount of aggregated pending fractional equity rewards surpassing a pending reward threshold, an indication may be sent to the average price account to execute a whole share purchase based on the aggregated pending fractional equity rewards. If the amount of aggregated pending fractional equity rewards do not equal a whole number of shares, the amount of aggregated pending fractional equity reward may be rounded-up to the nearest whole number of shares and the average price account may place a buy order for this number of whole shares (this is herein referred to as the whole share buy order). For example, if the amount of aggregated pending fractional equity rewards is 0.95 shares of stock Y, this amount may be rounded-up to 1.00 shares of stock Y, which is the nearest whole number of shares, and a buy order, or a whole share purchase, for this amount may be placed on a clearing system by the average price account. Once the whole share purchase order/buy order has been filled, the average price account may be debited a monetary value corresponding to the purchased whole shares of stock and the average price account may be credited with the purchased amount of whole shares of stock. Method 300 may then proceed to 316.

At 316, method 300 may include transferring a portion of the purchased whole shares to a merchant facilitation account and transferring a fractional remainder of the whole shares to a residual account. For example, based on 0.95 shares of stock Y of aggregated pending fractional equity rewards, 1.00 shares of stock Y may be purchased by the average price account, with a first portion of the purchased whole shares of stock going to a merchant facilitation account (0.95 shares in this example) in exchange for an amount of funds equivalent to the monetary value of the portion, and with the fractional remainder of shares (0.05 shares in this example) going to a residual account in exchange for an amount of funds equivalent to the monetary value of the fractional remainder of shares. Further, the allocation of the purchased whole shares of stock from the average price account to the merchant facilitation account and the residual account may occur within a threshold duration of the time at which the whole share purchase order was completed, such that the balance of shares in the average price account after the duration of time may be zero (until the next cycle of reward distribution for a given business registered with the loyalty platform). Method 300 may then proceed to 318.

At 318, method 300 includes distributing fractional equity rewards from the merchant facilitation account to a plurality of users, based on pending fractional equity rewards owed to the plurality of users. For example, the portion of the purchased whole shares in a given merchant facilitation account, may be distributed amongst the plurality of users in amounts equal to the pending fractional equity reward amounts owed to each user, such as were aggregated in step 310. For example, 0.8 shares of stock in a merchant facilitation account corresponding to business Z may be distributed to a user account of user A and a user account of user B, to satisfy pending fractional equity rewards of 0.2 shares of stock in business Z and 0.60 shares of stock in business Z, owed to user A and user B respectively, wherein 0.20 shares of the 0.80 shares are transferred to the account of user A and 0.60 shares of the 0.80 shares are transferred to the account of user B. An order of distribution of the portion of equity in the merchant facilitation account may be determined by the loyalty platform. In one example, the order of fractional equity reward distribution may be based on a timing of when the user loyalty purchases associated with each fractional equity reward occurred, such that users with rewards pending for longer durations may have an associated fractional equity reward distributed to an associated account before a user with a reward pending for a shorter duration. As the amount of shares of stock allocated to the merchant facilitation account is equal to an aggregated amount of pending fractional equity rewards, there may be no residual equity remaining in the merchant facilitation account upon completion of each reward distribution cycle. Method 300 may then proceed to 320.

At 320, method 300 may include displaying an updated equity reward status to one or more of the plurality of users to whom a fractional equity reward was distributed in step 318. In one example, the updated equity reward status may include a visual representation of the amount of fractional equity reward distributed to a user account on the loyalty platform, along with updated totals of equity held by the user account in a reward portfolio. The equity reward status may be rendered within a graphical user interface implemented by a display of a user computing device used to connect with the loyalty platform over a network, such as the Internet. In one example, the equity reward status may be transmitted to the user in the form of a push notification, an email, a text message, or other form of electronic communication. Upon distribution of an amount of fractional equity from a merchant facilitation account to a plurality of user accounts, each of the users associated with the plurality of user accounts may receive an updated equity reward status. An order of sending the updated equity reward statuses may be staggered to reduce consumption of bandwidth by the loyalty platform at any given instant to below a threshold level of bandwidth. Alternatively, each updated equity reward status may be sent out without staggering, and as such a plurality, or all, of the updated equity reward statuses may be sent out simultaneously. Each of the updated equity reward statuses may contain unique information, specifically pertaining to the associated user and user account. Method 300 may then proceed to 322.

At 322, method 300 includes aggregating fractional remainders of shares in the residual account and liquidating a whole number of shares from this aggregated amount based on the aggregated fractional remainders of shares exceeding a liquidation threshold, as is discussed in more detail with reference to FIG. 4. Method 300 may then proceed to 324.

At 324, method 300 may include charging the business (on whose behalf fractional equity rewards were distributed to the plurality of users) based on the distributed fractional equity rewards. In one example, the loyalty platform may charge a participating business after completion of a reward distribution cycle based on an amount of funds within a merchant deposit account associated with the participating business decreasing below a threshold amount of funds. Where, in one example, the threshold amount of funds may comprise a dollar amount projected to equal 10 days of fractional equity rewards, based on the current rate of fractional equity reward distribution for that business. The charge may comprise a first amount of funds needed to replenish the merchant deposit account associated with the business, and a second amount of funds to pay the loyalty platform service fee, where the service fee may have been previously agreed on within the Merchant Agreement between the loyalty platform and business. A bank account, or other payment account of the business, may transfer the first and second amount of funds to the loyalty platform via a payment system, such as payment system 150. The first amount of funds may be sent to the merchant deposit account, while the second amount of funds may be sent to a bank account of the loyalty platform, or alternatively, to an account within the loyalty platform. Method 300 may then end.

In this way, method 300 may enable fractional shares of stock to be distributed to a plurality of users more rapidly than conventional methods, while reducing the amount of equity needed to be maintained within an inventory account and reducing user frustration associated with lack of feedback regarding equity reward statuses.

Turning now to FIG. 4, an example method 400 for managing a residual account is shown. One or more of the steps of method 400 may be automatically executed by a loyalty platform, such as loyalty platform 108, configured with an equity allocation system, such as equity allocation system 120. As discussed previously with reference to FIG. 2, a residual account, such as residual account 250, may be included within a loyalty platform, and may perform functions related to managing residual securities unallocated after distribution of fractional equity rewards. In some examples, a residual account within a loyalty platform may also obtain and manage fractional shares of stock forfeit by users. Method 400 gives one example of a method by which a residual account of a loyalty platform may aggregate and liquidate fractional remainders of shares leftover after fractional equity rewards have been distributed to users, and may enable a reduction of the amount of equity held by a residual account of a loyalty platform, thereby also reducing a financial risk and/or regulatory burden associated with holding equity. Although the example of method 400 is given with reference to a single stock, it will be appreciated that the residual account may conduct similar, or the same, method of inventory management with each of a plurality of different stocks used by the loyalty platform to reward user purchases. In one example, there may be a plurality of residual accounts, each managing fractional remainders of shares for a single type of stock, and therefore there may be a one-to-one correspondence between a plurality of stocks used to reward users on a loyalty platform, and the plurality of residual accounts. In another example, a single residual account may be used, which is configured to hold the plurality of different stocks, and may execute management methods on each of the plurality of stocks.

Method 400 begins at 402, which may include aggregating fractional remainders of shares. As discussed above, during a fractional reward distribution cycle, a fractional remainder of shares of stock may be leftover after all pending fractional equity rewards (for that stock) are satisfied. This fractional remainder of shares, may be aggregated/accumulated within a residual account of the loyalty platform. In one example, a number of whole shares may be purchased by an average price account, and a portion of the whole shares (which may comprise a fractional number of shares) may be transferred to a merchant facilitation account as part of a reward distribution process (see FIG. 3). In many cases, the number of whole shares and the portion of shares may differ by a fractional share amount, thus leaving a fractional remainder of shares in the average price account. This fractional remainder of shares may be purchased by the residual account, and aggregated with any previously aggregated stock of the same type currently held by the residual account. Thus, after each reward distribution cycle for a given stock, an amount of aggregated fractional remainders of shares within the residual account may increase. Method 400 may then proceed to 404.

At 404, method 400 includes evaluating if the aggregated fractional remainders of shares are greater than a liquidation threshold. The liquidation threshold may be determined separately for each type of stock used by the loyalty platform to reward users, and may be based on the rate of reward distribution associated with a given stock (such as how rapidly are new rewards in a given stock earned), a volatility of the stock, and a price of the stock. The liquidation threshold may comprise a non-negative, non-zero number of shares of a given stock, and may be a fractional or whole number of shares. In one example, the comparison between the amount of aggregated fractional remainders of shares and the liquidation threshold may occur after each reward distribution cycle for a given stock. In another example, the comparison may occur after each aggregation event (that is, after new fractional remainders of shares are added to the inventory). In yet another example, the comparison may occur at regular, predetermined intervals. If at 404, the loyalty platform determines that the aggregated fractional remainders of shares are below the liquidation threshold, method 400 may return to 402 and continue to aggregate fractional remainders of shares. However, if at 404 the loyalty platform determines that the aggregated fractional remainders of shares are greater than the liquidation threshold, method 400 may proceed to 406.

At 406, method 400 includes liquidating a whole number of shares from the residual account by executing a whole share sell on the open market. The number of whole shares to be sold may be based on a difference between the liquidation threshold and the aggregated amount of fractional remainders of shares. For example, as the difference between the fractional remainders of shares and the liquidation threshold increases (that is, as the fractional remainders of shares increases above the liquidation threshold) the number of whole shares to be sold via the whole share sell may increase, thereby enabling the fractional remainders of shares held in the residual account (for a given stock) to be reduced to below a liquidation threshold even if the amount of fractional remainders of shares is well above the liquidation threshold. In another the whole number of shares liquidated may comprise a largest number of whole shares within an amount of aggregated fractional remainders of shares. For example, if there is 5.3349 shares of stock X within a residual account of a loyalty platform, based upon a liquidation threshold of 5.0 shares of stock X, the residual account may place a sell order for the largest number of whole shares of stock X, which is 5.0 shares in this case.

In another example, the minimum number of whole shares may be liquidated, such that the amount of aggregated fractional remainders of shares is reduced to below the liquidation threshold. In an example, if there is 5.3349 shares of stock X within a residual account of a loyalty platform, based upon a liquidation threshold of 5.0 shares, the residual account may place a sell order for the minimum number of whole shares which would result in the amount of aggregated fractional remainders of shares being reduced to below the liquidation threshold, which in this case would be 1.0 shares (and the amount remaining would be 4.3349 shares of stock X). Executing a whole share sell may include placing a whole share sell order on one or more securities markets, such as the NYSE, via a clearing system, such as clearing system 104. Funds obtained from liquidating whole numbers of shares from the fractional remainders of shares within the residual account may be used to replenish funds spent by the residual account to purchase fractional remainders of shares, and in that way the amount of new funds to be transferred to the residual account to enable it to purchase fractional remainders of shares may be reduced. Method 400 may then end.

In this way, method 400 may enable efficient reduction in the amount of equity held in a residual account of a loyalty platform, by liquidating whole numbers of aggregated fractional remainders of shares based on a liquidation threshold.

Turning now to FIG. 5, an example method 500 for aggregating and executing user sell orders, which may comprise sell orders for fractional shares of stock. One or more of the steps of method 500 may be automatically executed by a loyalty platform, such as loyalty platform 108, configured with an equity allocation system, such as equity allocation system 120. Method 500 may enable user sell orders for fractional shares of stock to be rapidly executed, without the loyalty platform directly buying back fractional shares of stock from users. Conventionally, a difficulty of dealing in fractional shares of stock is that securities markets generally do not deal in fractional shares of stock, and therefore a user wishing to execute a sell order for an amount of fractional shares may be required to pay additional fees for such an order, or may simply be unable to complete such an order. Method 500 may mitigate this issue, without requiring the loyalty platform to directly purchase fractional shares of stock from its users.

Method 500 begins at 502, which includes aggregating user fractional sell orders. In one example, fractional sell orders may be computationally aggregated, such as by summing all pending user sell orders. Alternatively, user sell orders may be aggregated by transferring user equity to be sold to an account, such as the average price account, and pooling/aggregating the equity to be sold with the account. Upon placing a sell order, a user may receive a sell order status displayed via a display of a computing device associated with the user. The sell order status may indicate to the user the amount of equity to be sold, such as by rendering the amount within a graphical user interface, which may comprise an amount of fractional shares of stock, as well as an indication of what stage of the sell process the sell order is currently in. Method 500 may then proceed to 504.

At 504 method 500 includes evaluating if the aggregated fractional share sell order amount is greater than a sell order threshold. This evaluation may occur upon each new user sell order for a given stock. Alternatively, the evaluation may occur at regular, pre-determined intervals of time. The sell order threshold may be based on a rate of sell order aggregation, a time since placement of the oldest sell order in the aggregated sell order, and liquidity of the stock comprising the sell order (such as may be indicated by evaluating volume of trade on the open market for the stock). Alternatively, the sell order threshold may be a pre-determined value. The sell order threshold may be unique for each of the plurality of stocks used to reward users on the loyalty platform. As an example, the sell order threshold may comprise a whole number of shares, or alternatively the sell order threshold may comprise a fractional amount of shares. In one example, a default sell order threshold may be adjusted based on a duration of time since the oldest sell order in the aggregated sell order being evaluated was placed. In a specific example, a default threshold of 5.0 shares of stock may be decremented to 4.0 shares of stock based on the length of elapsed time since the first sell order within the aggregated sell order was placed surpassing a threshold. For example, a based on the oldest sell order within an aggregated sell order exceeding a threshold wait time of 1 day, a sell order threshold may be decreased. In this way, a duration of wait for execution of a user sell order may be reduced. In another example, a sell order threshold may comprise a predetermined whole number of shares, such as 1.0 shares. If at 504 the loyalty platform determines that the aggregated fractional share sell order amount is not greater than the sell order threshold, method 500 may return to 502, and continue to aggregate fractional share sell orders from the plurality of users. However, if at 504 it is determined that the aggregated fractional share sell order is greater than a sell order threshold, method 500 may proceed to 506.

At 506, method 500 includes liquidating a number of whole shares of the aggregated fractional share sell order. The number of whole shares liquidated from the aggregated fractional share sell order may be based on the amount of the aggregated fractional share sell order. In one example, the maximum number of whole shares within the aggregated fractional share sell order may be sold. As a specific example, based on an aggregated fractional share sell order amounting to 2.566 shares of stock X, a whole share sell order for 3.0 shares of stock X may be placed with a clearing system. Funds obtained from liquidating whole shares of stock comprised of a plurality of aggregated user fractional share sell orders may be allocated to the plurality of user accounts associated with the plurality of aggregated user fractional share sell orders. As an example, if user A placed a sell order for 0.5 shares of stock X, and user B placed a sell order for 0.5 shares of stock X, based on a liquidation threshold of 1.0 shares of stock X, a whole share sell order may be placed, and executed, for the 1.0 shares. Funds from the whole share sell for the 1.0 shares of stock X may be distributed to user accounts associated with user A and user B in proportion to the amount of the executed sell order comprising stock owned by that user, so in this case 50% of the funds go to an account belonging to user A, and 50% of the funds go to an account belonging to user B. Upon execution of the whole share sell order based on the aggregated fractional share sell orders, method 500 may then end.

In this way, sell orders for fractional shares of equity, which may conventionally require additional fees or time to sell, may be efficiently and timely sold, by aggregating fractional share sell orders from a plurality of users, and executing a whole share sell order based on the amount of the aggregated fractional share sell orders exceeding a sell order threshold.

Turning now to FIG. 6 an example method 600 for distributing fractional shares of stock to users of a loyalty platform based on tracked user loyalty purchases is shown. On the left side of FIG. 6, a column is displayed which indicates what agent/system performs a given step of the method. A step, indicated by a box in the flowchart, horizontally aligned (such as within a same row of a matrix) with an agent/system in the left hand column may be considered to be performed by that agent/system for purposes of example method 600. As a specific example, step 628 of method 600 is horizontally aligned with “Merchant”, which indicates that step 628 is conducted by a business registered with the loyalty platform, which may herein also be referred to as a merchant. Running along the bottom of FIG. 6, is an arrow labeled “TIME”, this arrow indicates the chronology of the steps of method 600, with steps to the right occurring later, steps to the left occurring earlier, and steps vertically aligned occurring substantially concurrently, or within a threshold duration of time of one another. For example, steps aligned vertically may occur within the same 24 hour duration of time.

Method 600 begins at 602, wherein a user executes a user loyalty purchase using a linked payment medium. The linked payment medium may comprise a credit card, debit card, other payment card, cellphone based payment app, NFC based payment system, or other types of electronic payment systems which may provide a digital record of a transaction. Method 600 may then proceed to 602.

Step 602 of method 600 includes the payment being accepted by the merchant. The merchant in this example comprises a business registered with the loyalty platform, and to whom the user (as indicated by the “user” in the left hand column of FIG. 6), has made a loyalty selection (wherein the loyalty selection may be stored in a user account associated with the user on non-transitory memory of one or more computing systems implementing a loyalty platform). Once the user's payment is accepted by the merchant, method 600 may proceed to step 604.

At step 604, method 600 may include the payment medium company processing the payment made during the user loyalty purchase. For example, in the case that the linked payment medium comprises a credit card, step 604 may comprise the credit card company processing the new charge made by the account (the account in this example referring to a user account within the credit card company) to which the user loyalty purchase was charged, and from which funds were obtained to complete the purchase. Processing of the payment may include recording one or more details associated with the user loyalty purchase, such as a date, time, and physical location of the purchase. Once the payment has been processed by the payment medium company, method 600 may proceed to step 606.

At step 606, method 600 includes the loyalty platform receiving transaction details associated with the user loyalty purchase. In one example, a third party data aggregator may compile and transmit purchase details from a plurality of different payment medium companies, such as various banks, credit card companies, etc. In another example, the payment medium company may provide purchase details directly to the loyalty platform. Method 600 may then proceed to step 608.

At step 610, method 600 includes identifying if a valid user loyalty purchase occurred based on the tracked purchase details. In one example, purchase details may be correlated with a database associated with the loyalty platform, such as rewarding-business index 186, to ascertain if the business at which the purchase occurred is registered with the loyalty platform, and currently offering fractional equity rewards to users. Further, step 610 may include looking up a user's loyalty selections, such as by identifying which user account is associated with a tracked purchase (which may be accomplished by determining which account registered a payment medium used to conduct the transaction) and then determining if the user has an active loyalty selection to the business with which the purchase was executed. If at 610 it is determined that a valid user loyalty purchase occurred, method 600 may proceed to step 612.

At step 612, method 600 includes determining/calculating a fractional share amount (a fractional equity reward) to reward the user based on the tracked user loyalty purchase. The determination may be based on a duration of user loyalty selection to the business, a transaction history of the user, a dollar amount (monetary value) of the purchase, and reward policies of the business, stored within the loyalty platform. Once a fractional share amount to reward the user has been determined, method 600 may proceed to step 614.

At step 614, method 600 includes displaying an equity reward status to the user. In one example the equity reward status may include an indication of fractional share amount to which the user is now entitled based on the recently conducted user loyalty purchase, the equity reward status may further include an indication of a timing of distribution of the fractional share amount. Method 600 may then proceed to step 616.

At step 616, method 600 includes invoicing the merchant for the dollar amount of the fractional equity reward, the invoice may further include one or more charges, such as a service fee for the loyalty platform. Method 600 may then proceed to step 628, which includes the merchant issuing a payment to the loyalty platform based on the invoice. At step 630, the loyalty platform may receive the payment from the merchant, and may allocate the received funds. In one example, a portion of the funds may be allocated to a merchant deposit account to provide future rewards of the merchant with fractional equity rewards based on user loyalty purchases.

Returning to step 612, method 600 may also proceed to 618, which includes the loyalty platform aggregating fractional equity rewards and issuing a whole share buy order with a clearing system based on the aggregated rewards. Fractional equity rewards aggregated together may comprise shares of stock in a given business, so that pending fractional equity rewards of stock X are aggregated together into a first aggregate amount, while pending fractional equity rewards of stock Y are aggregated together into a second aggregate amount, but the first and second amounts may not be aggregated together, and no aggregate amount of a mixed stocks may occur. The amount of the whole share buy order may be determined as discussed in more detail above. As one example, the whole share buy order may comprise a number of whole shares within one share of the amount of aggregated fractional equity rewards. As a specific example, based on pending fractional equity reward amount of 2.35 shares of stock X, a whole share buy order of 3.0 shares of stock X may be placed. The 3.0 shares is the rounded-up amount of the aggregated pending fractional equity rewards. Method 600 may then proceed to step 620

At step 620, method 600 includes a clearing system executing the whole share buy order placed in step 618. Method 600 may then proceed to 622.

At step 622, method 600 includes the whole share buy order being filled. Method 600 may then proceed to step 624.

At step 624, method 600 includes the loyalty platform receiving from the clearing system the purchased amount of whole shares. The purchased amount of whole shares my deposited within an average price account of the loyalty platform, and may subsequently be allocated to a plurality of users to satisfy pending fractional equity rewards of the plurality of users. This may include first transferring a portion, equal to the aggregated pending fractional equity rewards, from the average price account to a merchant facilitation account, before apportioning the portion in the merchant facilitation account amongst the plurality of users. A fractional remainder of shares leftover after satisfying the pending fractional equity rewards may be purchased by, and stored within, a residual account of the loyalty platform. Method 600 may then proceed to step 626.

At step 626, method 600 includes displaying an updated equity reward status to a user via a display of a user computing device. The updated equity reward status may indicate that an amount of fractional equity has been transferred to an account associated with the user. The updated equity reward status may further included updated totals for equity held within the account of the user on the loyalty platform. Method 600 may then end.

Focusing now on FIG. 7, one specific example of a process for distributing a fractional equity reward to a user is illustrated. The example includes transactions between an average price account, a residual account, a merchant facilitation account and merchant deposit account (the merchant being Home Depot “HD” in this example), and a user account. Funds from the average price account are used to purchase a number of whole shares of HD stock, a portion of the whole shares is purchased by a merchant facilitation account (using funds which originate from a merchant deposit account) and transferred to a user account to satisfy a pending fractional equity reward, while a fractional remainder of shares of the whole shares is purchased by the residual account.

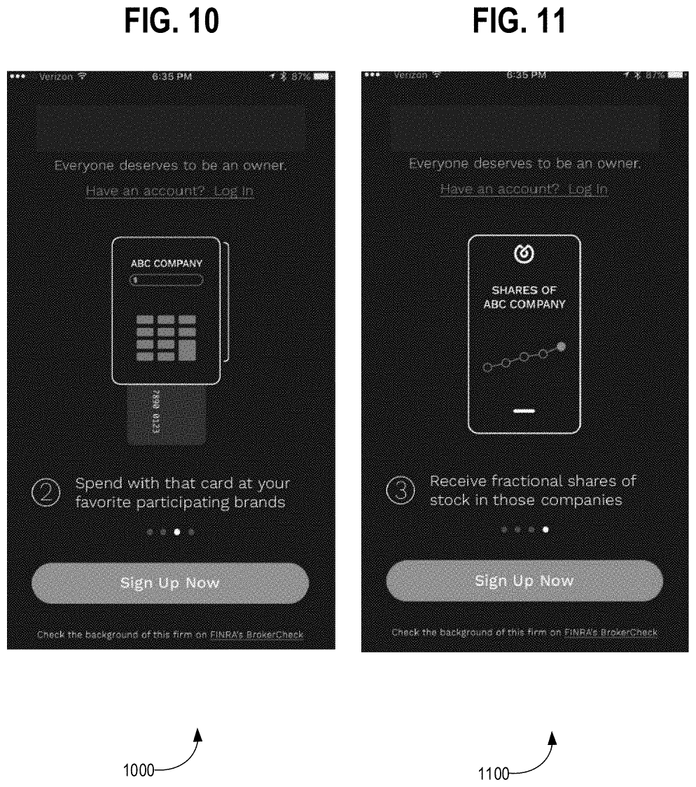

FIGS. 8, 9, 10, and 11, illustrate example graphical user interfaces 800, 900, 1000, and 1100, which may be displayed via a user computing device prior to a user creating an account with the loyalty platform.

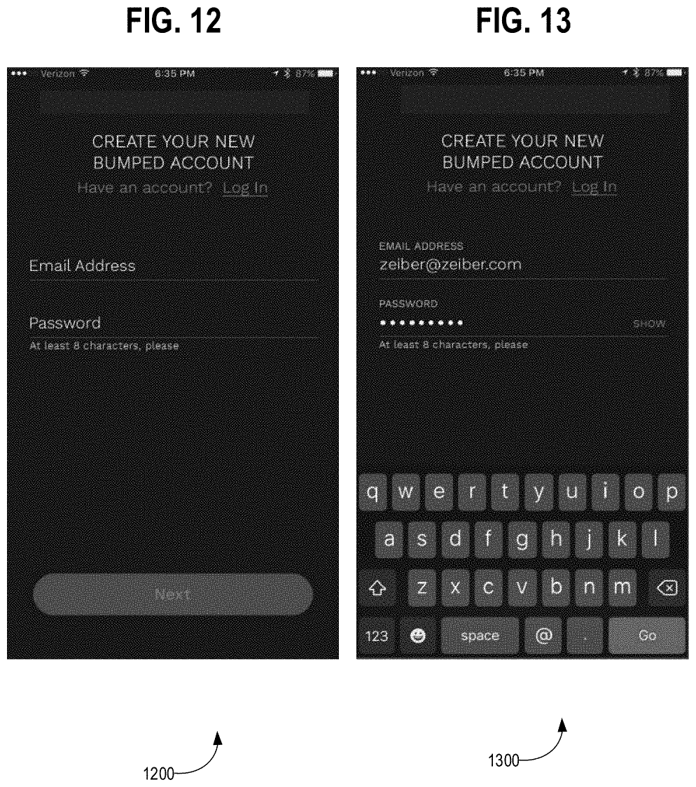

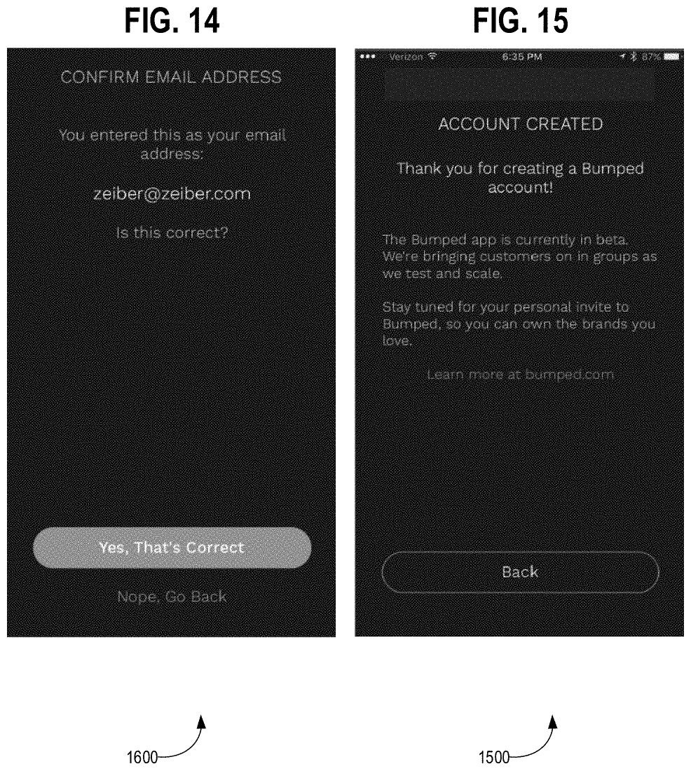

FIGS. 12, 13, 14, and 15 illustrate example graphical user interfaces 1200, 1300, 1400, and 1500, which may be displayed via user computing device during the process of initial user account creation, such as when a user is first signing up with the loyalty platform.

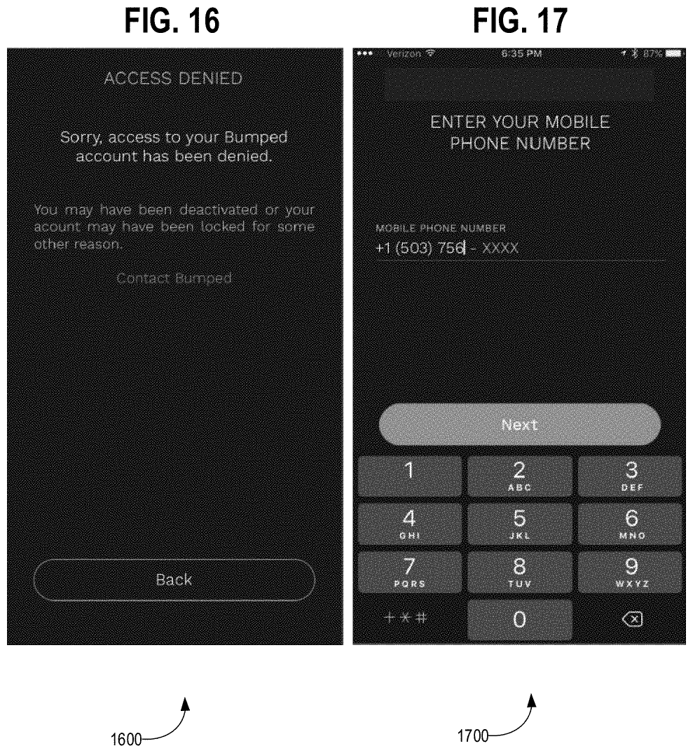

FIGS. 16, and 17 illustrate example graphical user interfaces 1600, and 1700, which may be displayed via user computing device during if the user incorrectly inputs an account password, such as may occur during an attempted login to a user account on the loyalty platform.

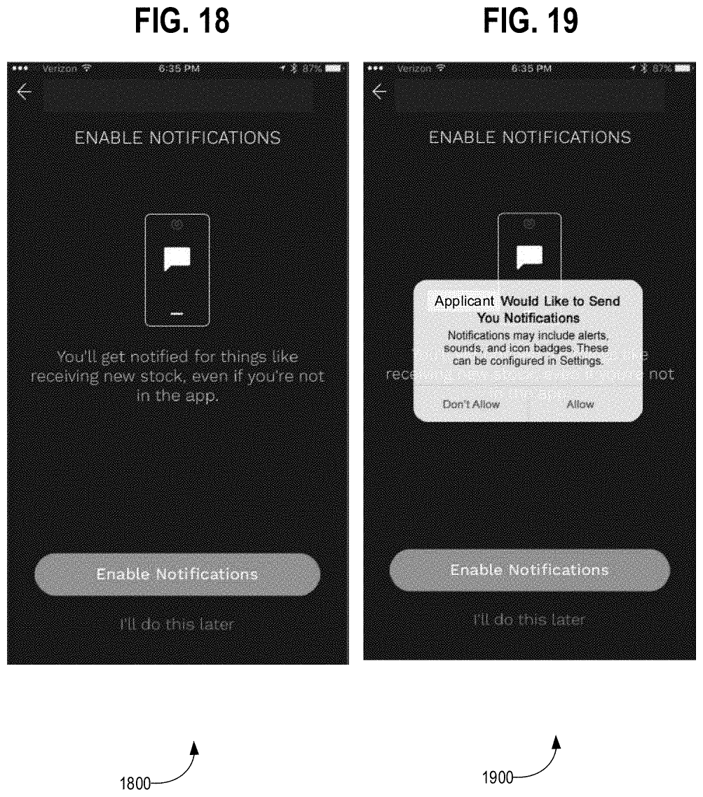

FIGS. 18, and 19 illustrate example graphical user interfaces 1800, and 1900, which may be displayed via user computing device during an initial account login (such as during the first time a user logs into a user account on the loyalty platform) which may prompt the user to enable push notifications for the loyalty platform app.

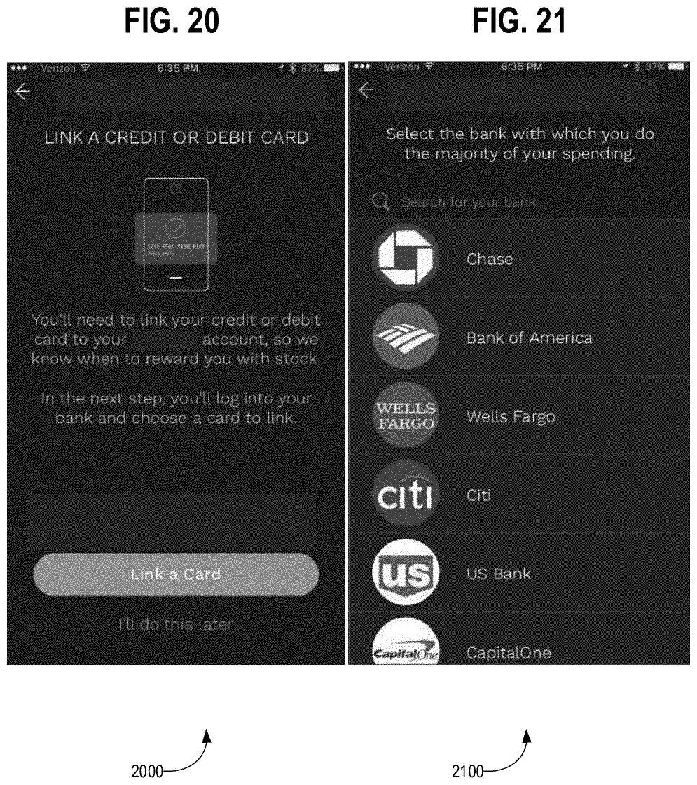

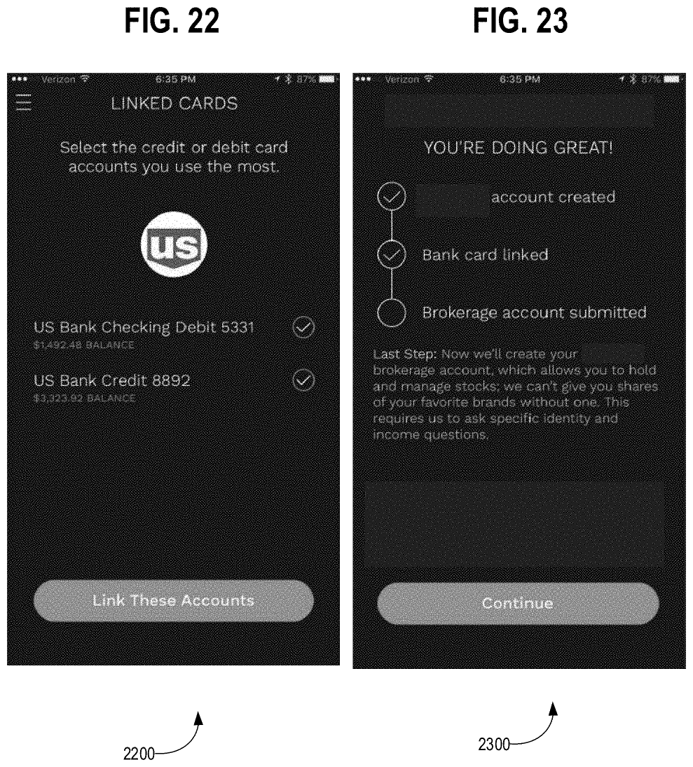

FIGS. 20, 21, 22, and 23 illustrate example graphical user interfaces 2000, 2100, 2200, and 2300, which may be displayed via user computing device during the process of linking a payment medium to a user account of the loyalty platform.

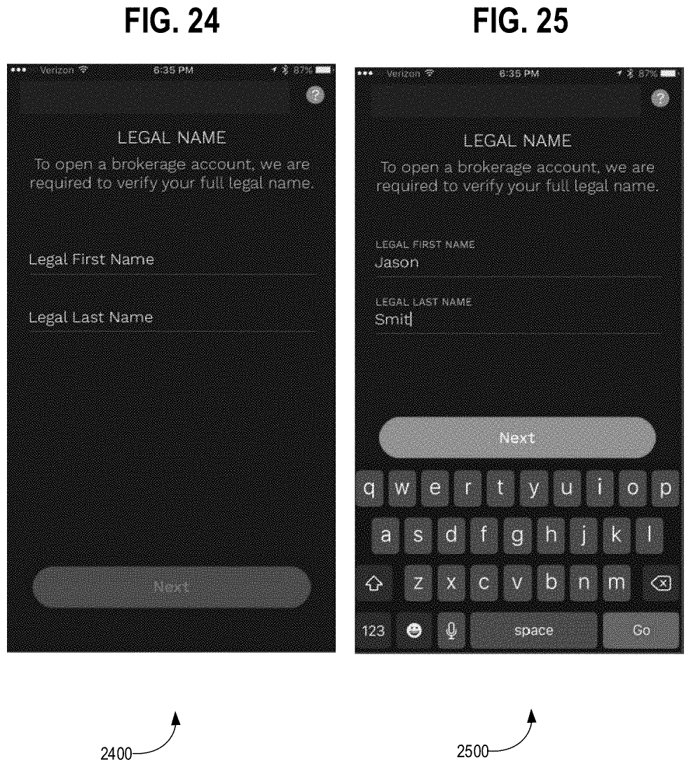

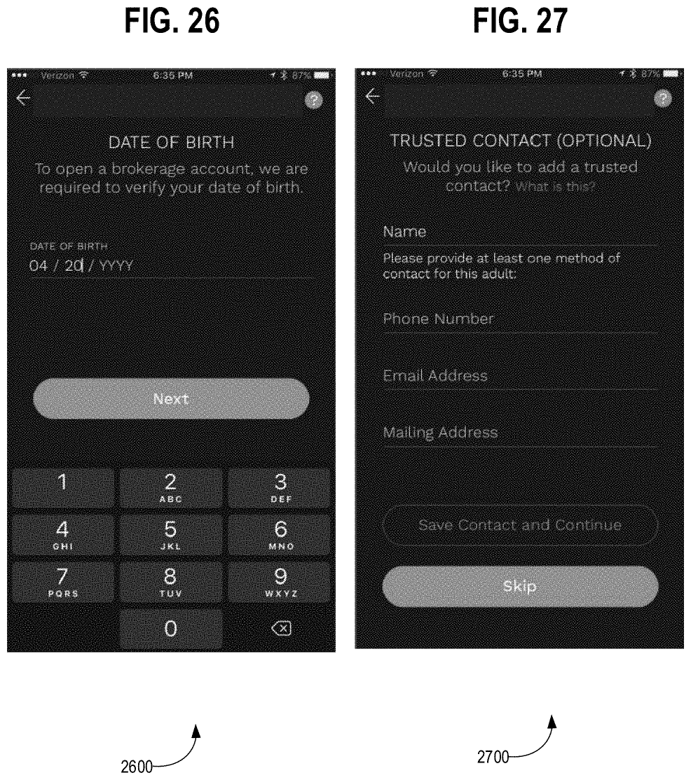

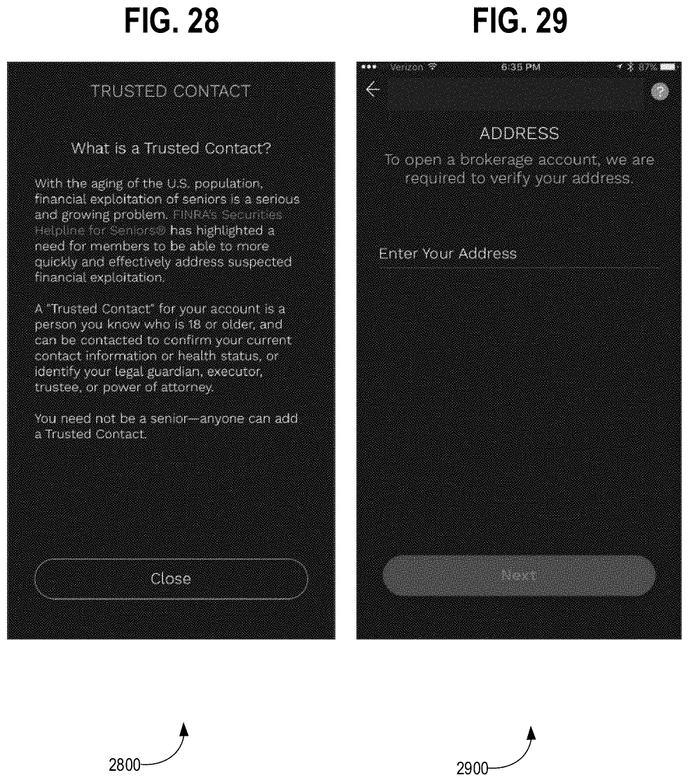

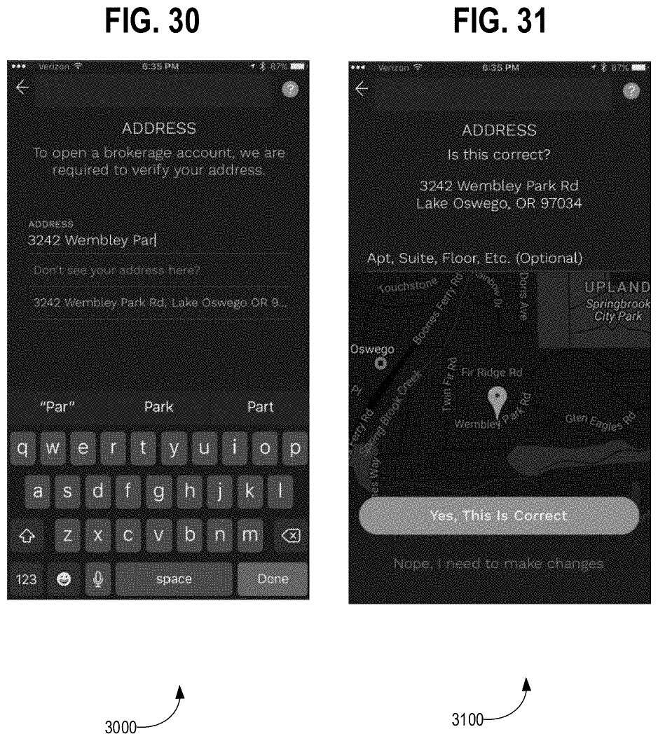

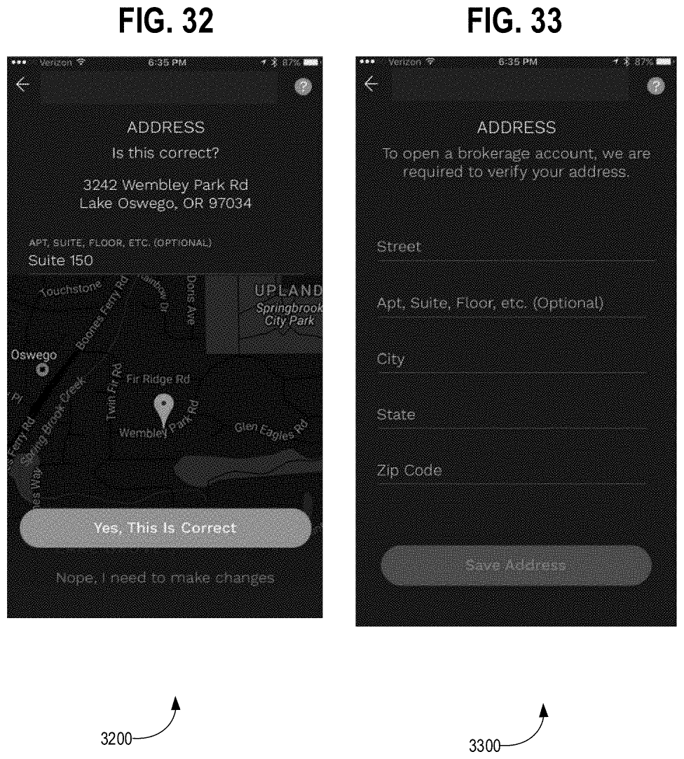

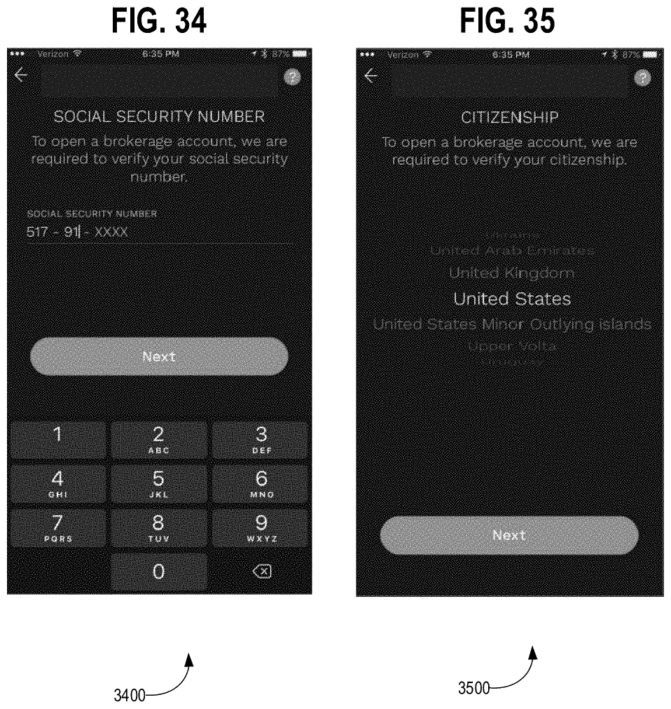

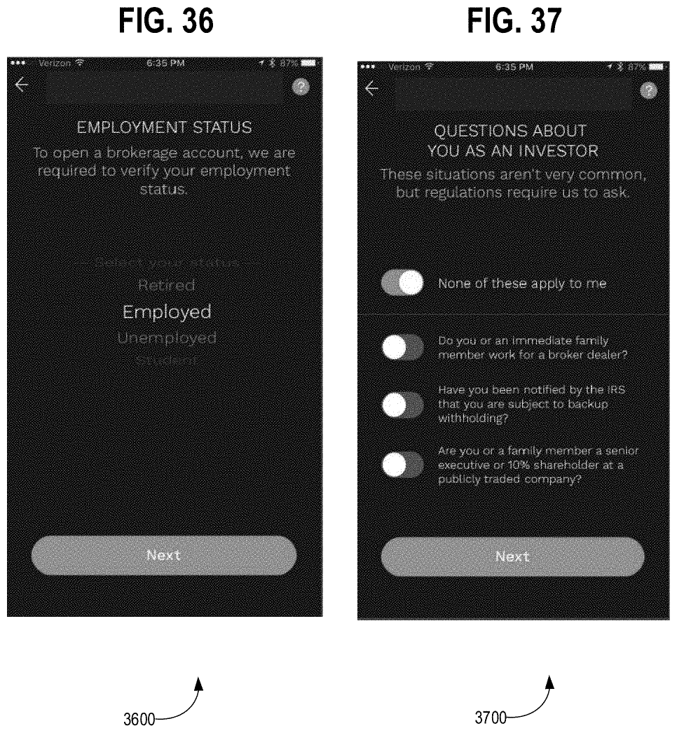

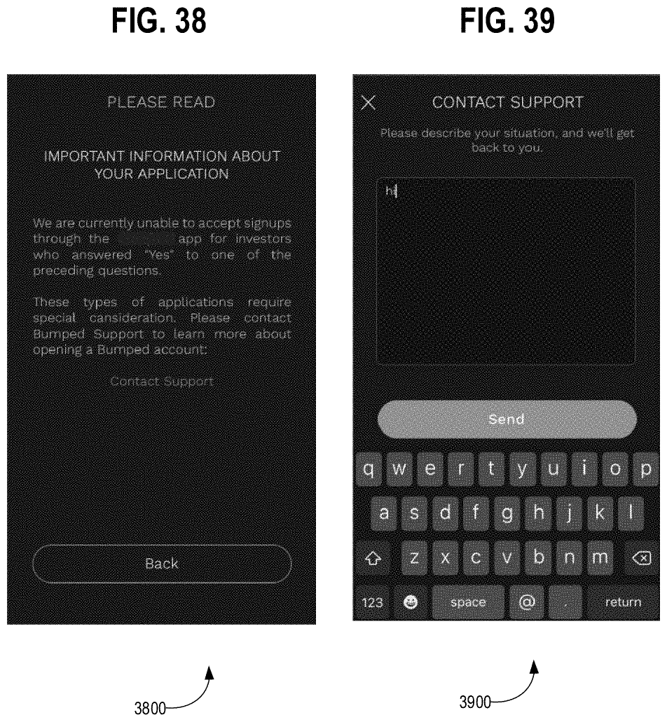

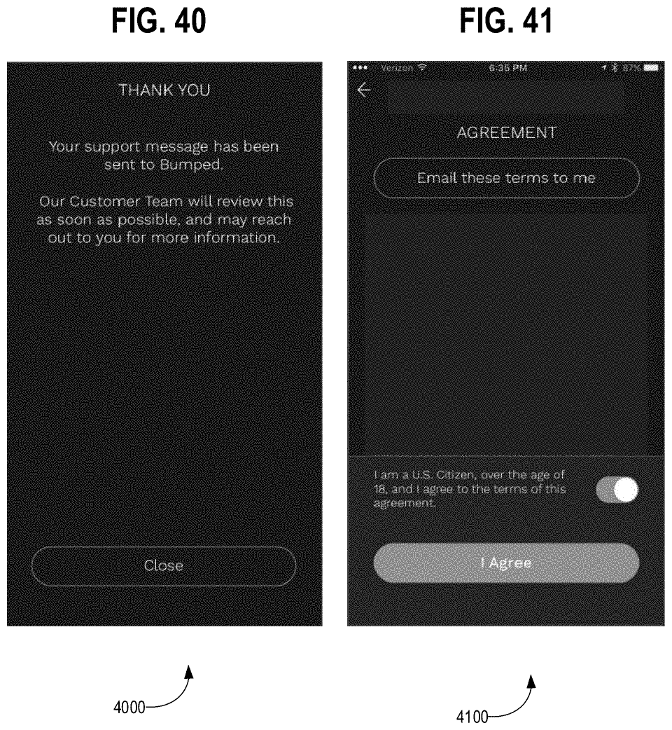

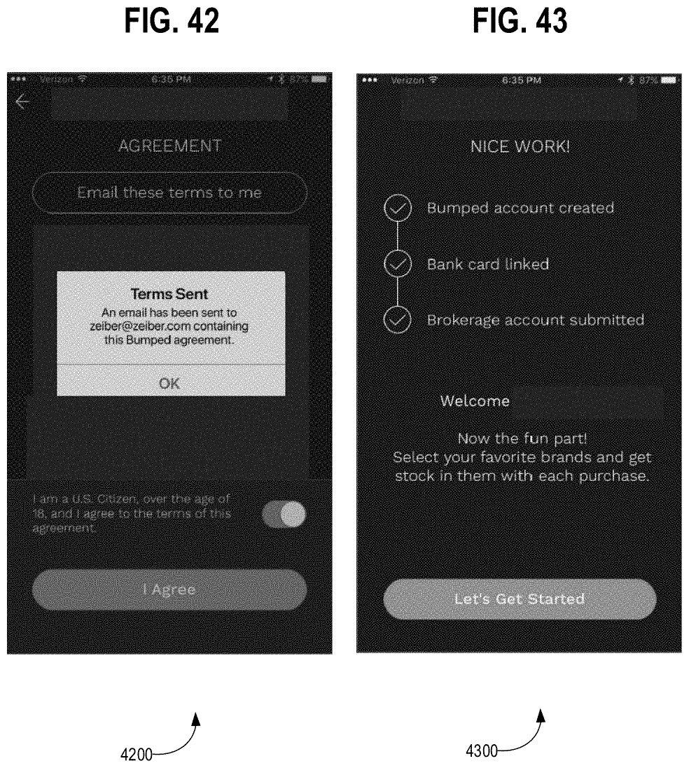

FIGS. 24, 25, 26, 27, 28, 29, 30, 31, 32, 33, 34, 35, 36, 37, 38, 39, 40, 41, 42, and 43 illustrate example graphical user interfaces 2400, 2500, 2600, 2700, 2800, 2900, 3000, 3100, 3200, 3300, 3400, 3500, 3600, 3700, 3800, 3900, 4000, 4100, 4200, and 4300 which may be displayed via user computing device during the process of applying for a brokerage account on the loyalty platform. Successfully submitting a brokerage account application may enable a user to hold, trade, buy, and sell, equity through the loyalty platform.

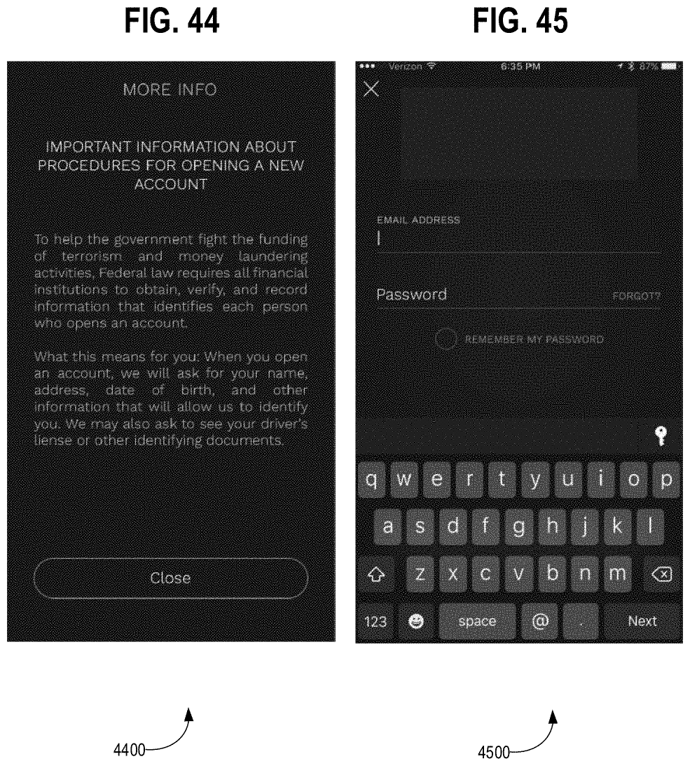

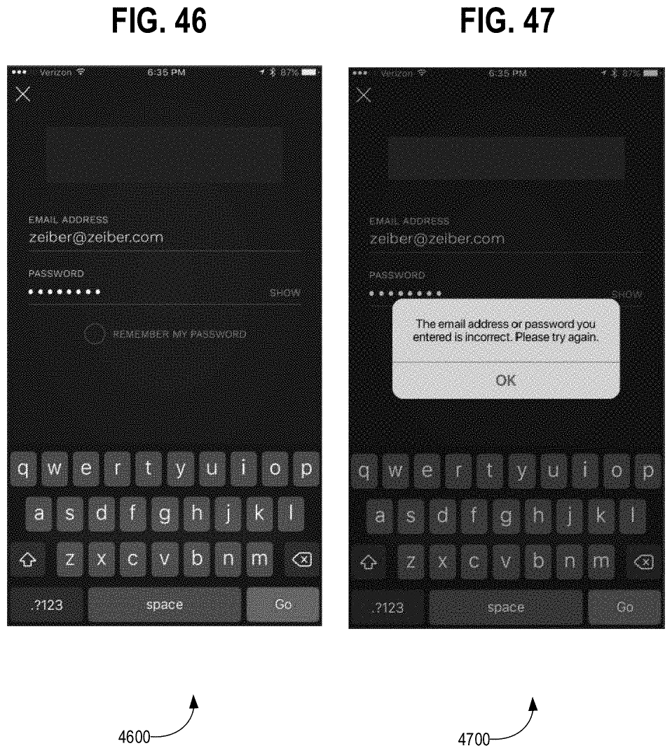

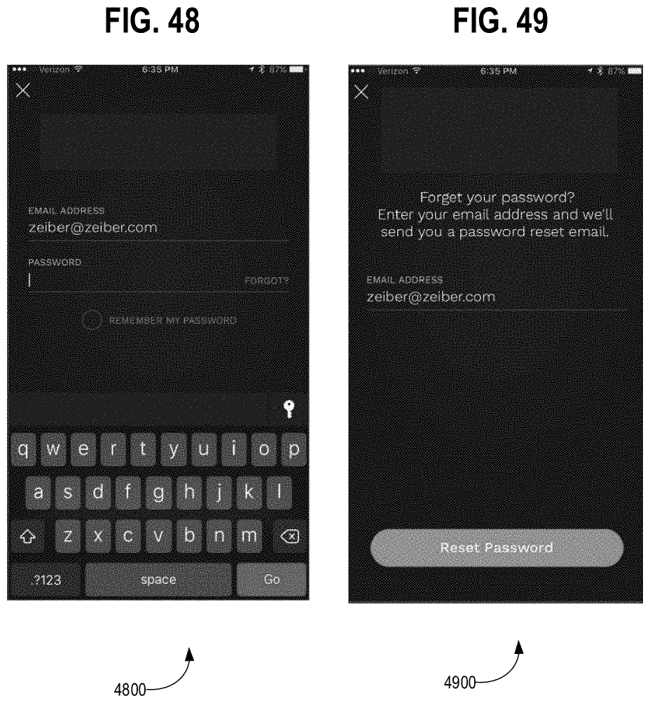

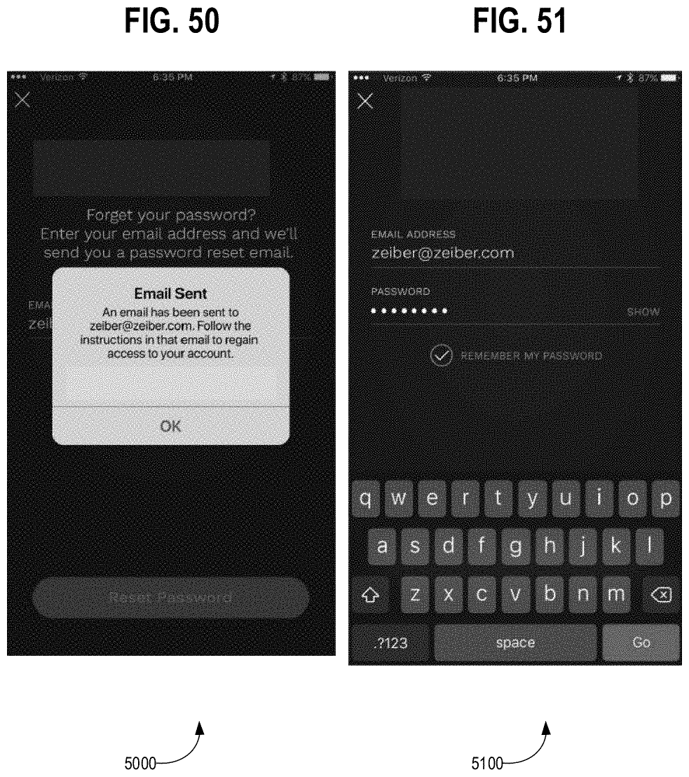

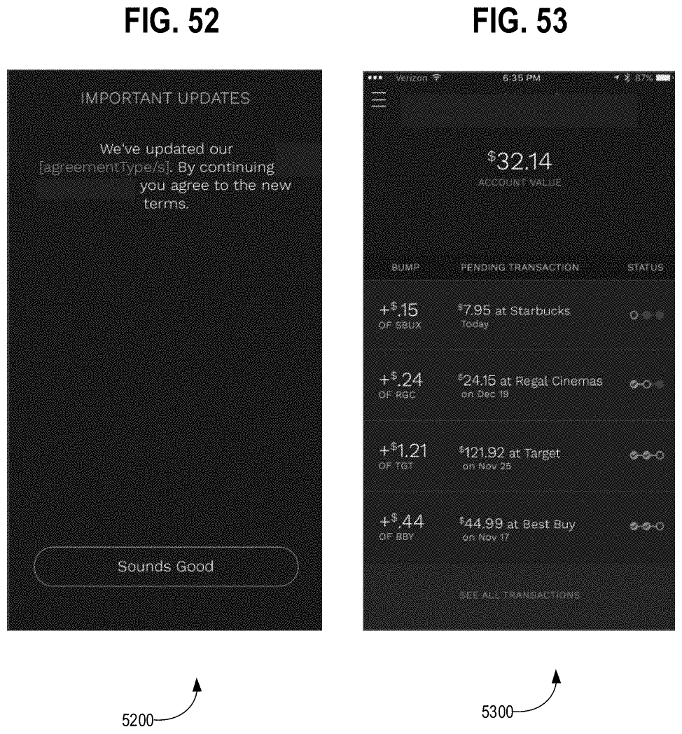

FIGS. 44, 45, 46, 47, 48, 49, 50, 51, and 52, illustrate example graphical user interfaces 4400, 4500, 4600, 4700, 4800, 4900, 5000, 5100, and 5200 which may be displayed by the loyalty platform via a user computing device during the process of logging into a user account of the loyalty platform.

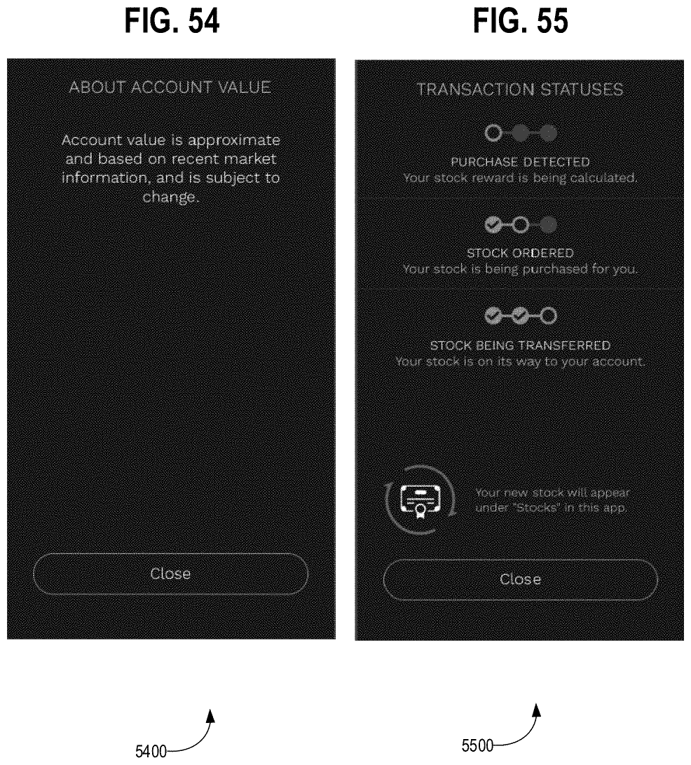

FIGS. 53, 54, and 55, illustrate example graphical user interfaces 5300, 5400, and 5500 which may be displayed by the loyalty platform via a user computing device during the process of fractional equity reward distribution. Interface 5300, and 5500, give two examples of equity reward statuses which may be displayed to a user to indicate a current status of one or more pending fractional equity rewards.

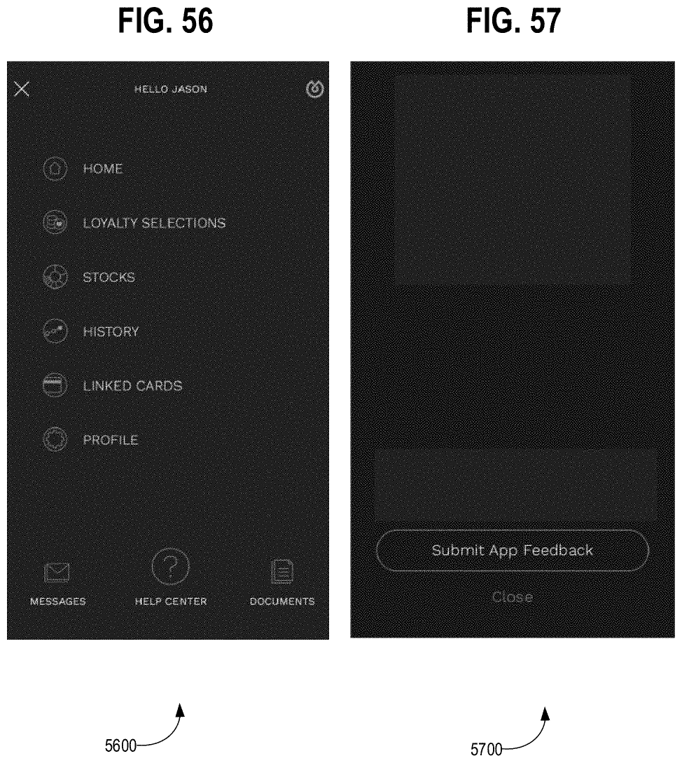

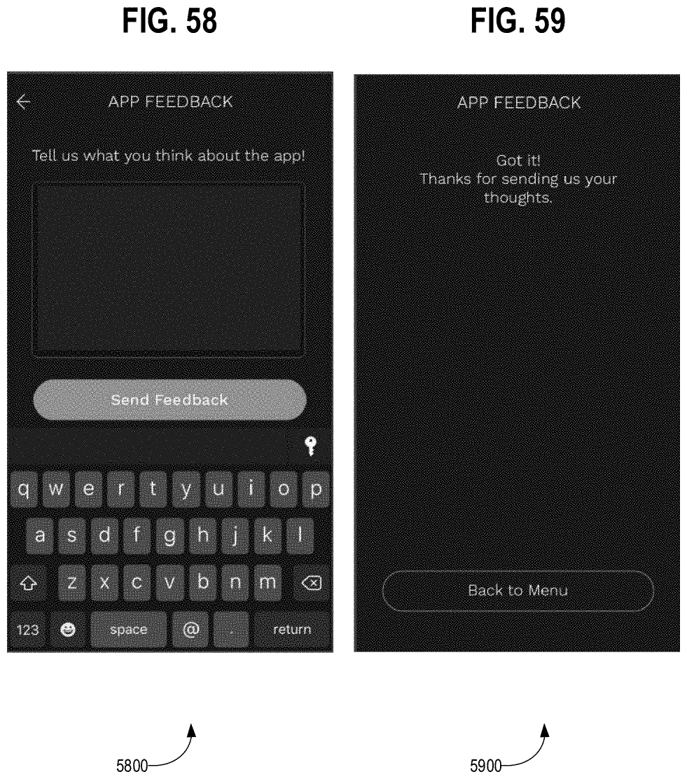

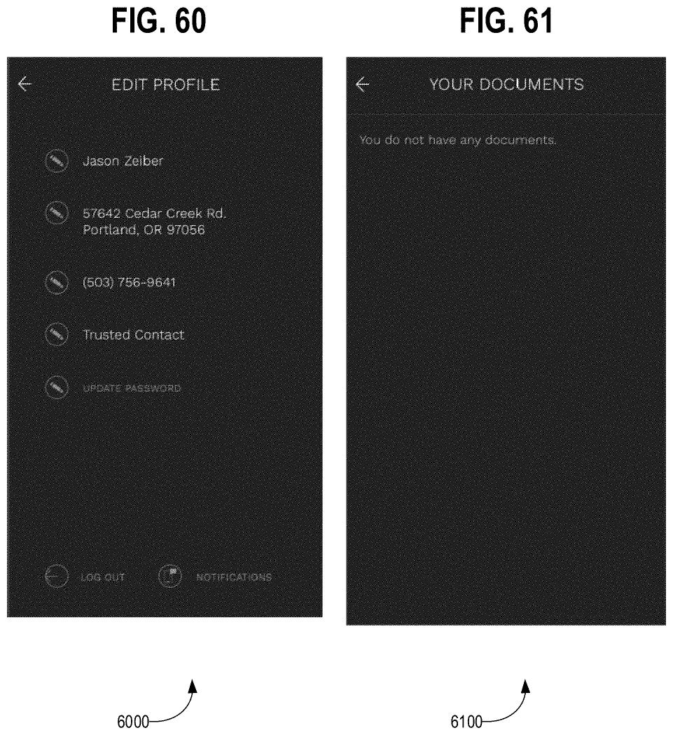

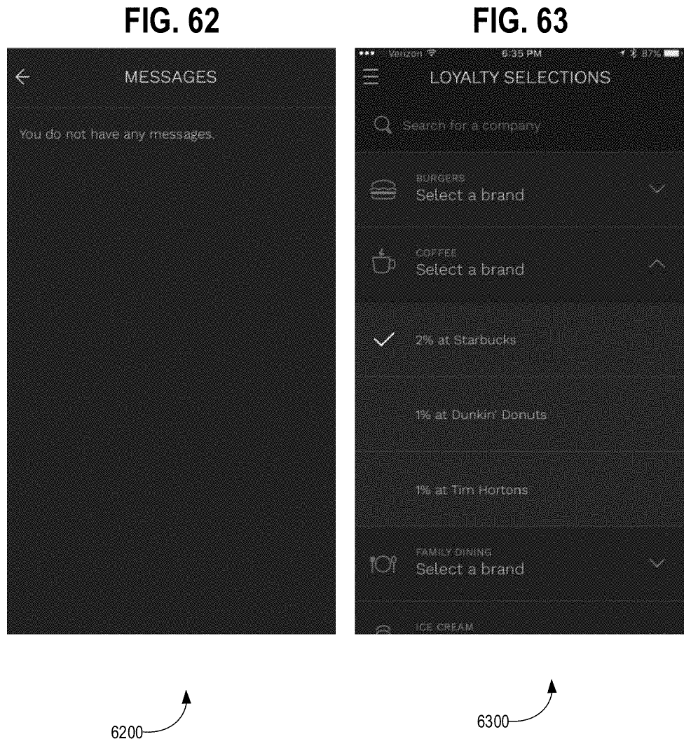

FIGS. 56, 57, 58, 59, 60, 61, and 62, illustrate example graphical user interfaces 5600, 5700, 5800, 5900, 6000, 6100, and 6200 which may be displayed by the loyalty platform via a user computing device while a user navigates through the main menu of a user account of the loyalty platform app.

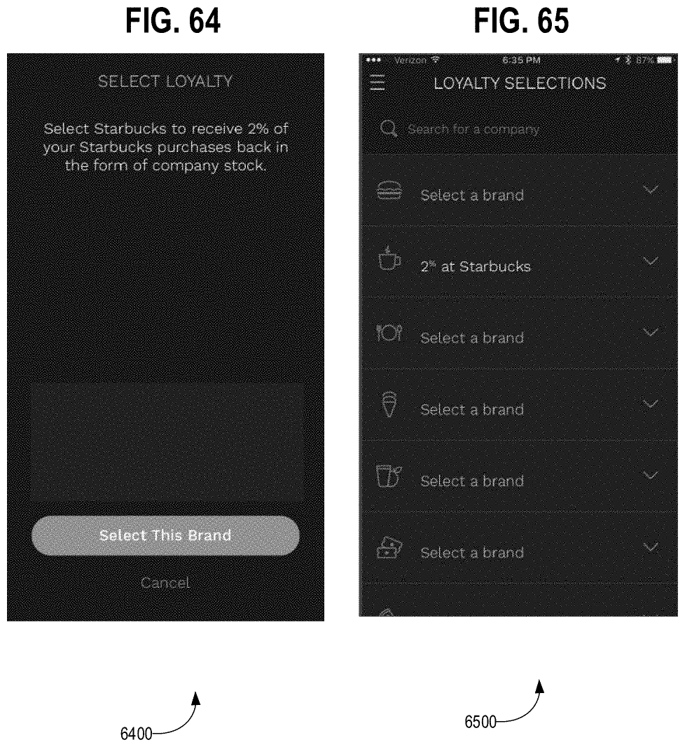

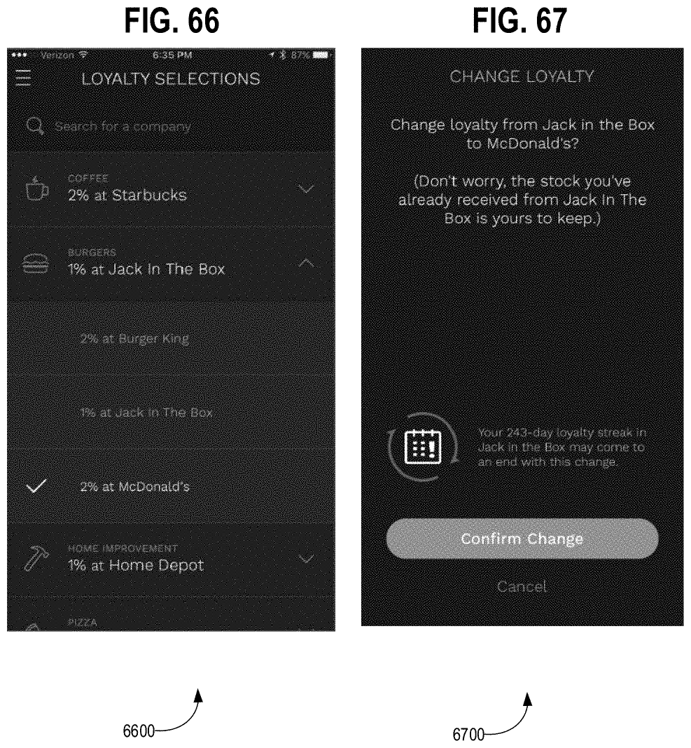

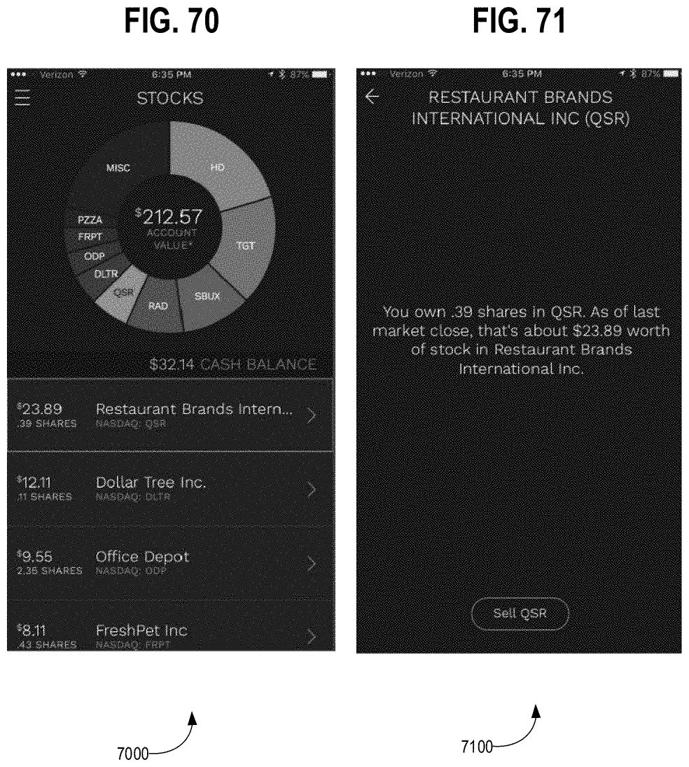

FIGS. 63, 64, 65, 66, 67, 68, 69, 70, and 99 illustrate example graphical user interfaces 6300, 6400, 6500, 6600, 6700, 6800, 6900, 7000, and 9900 which may be displayed by the loyalty platform via a user computing device to illustrate a user's current loyalty selections, and reward portfolio (a reward portfolio comprises received user equity rewards).

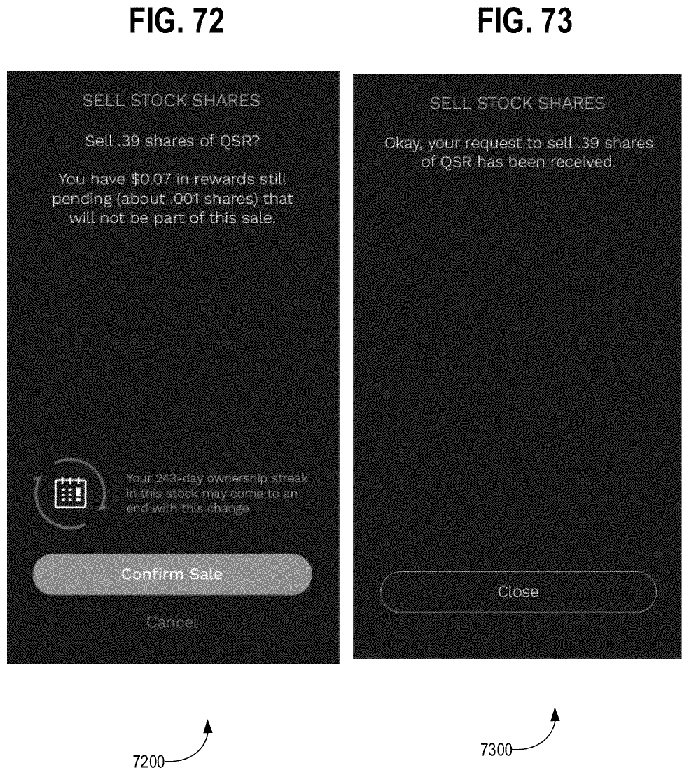

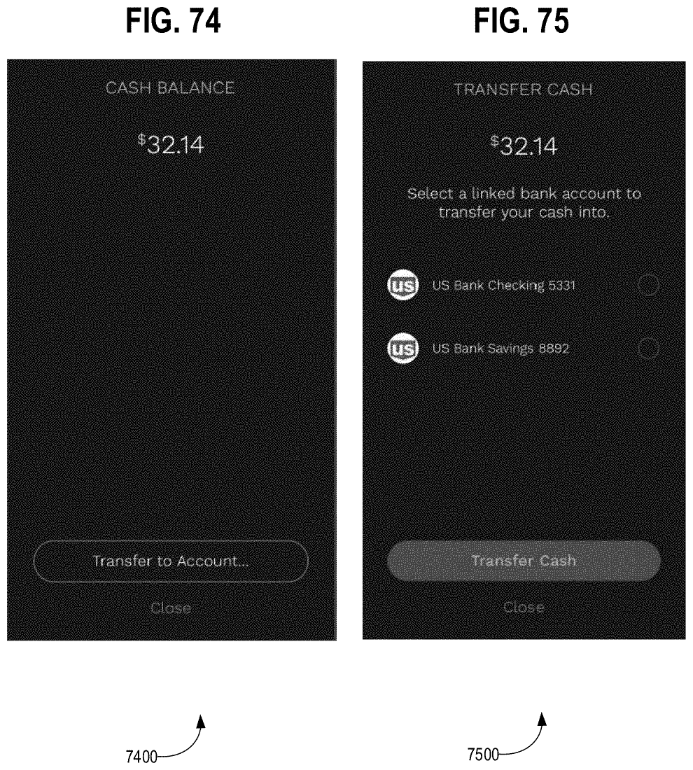

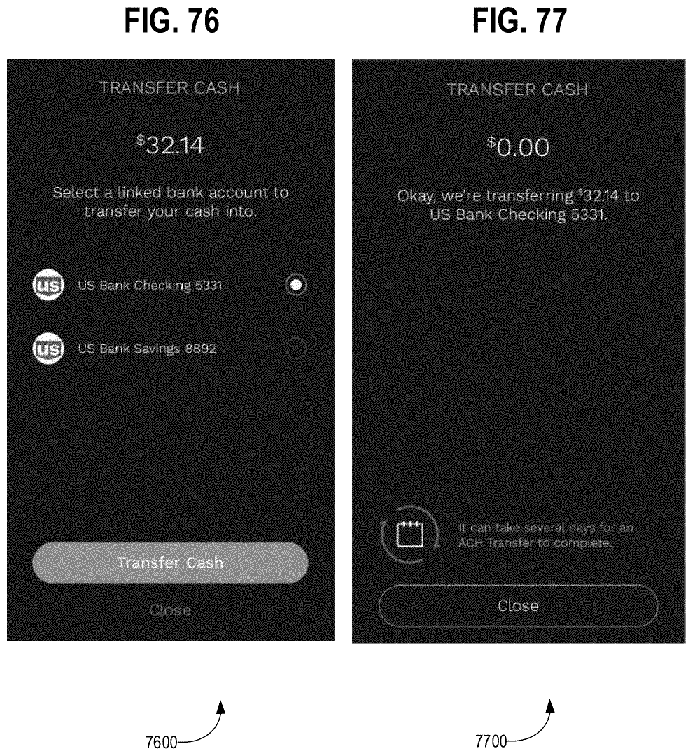

FIGS. 71, 72, 73, 74, 75, 76 and 77, illustrate example graphical user interfaces 7100, 7200, 7300, 7400, 7500, 7600 and 7700, which may be displayed by the loyalty platform via a user computing device to during an equity reward sell process, which may comprise placing a user sell order for part, or all, of fractional equity rewards accumulated by a user in a user account. The user sell order may comprise a sell order for an amount of fractional shares of stock.

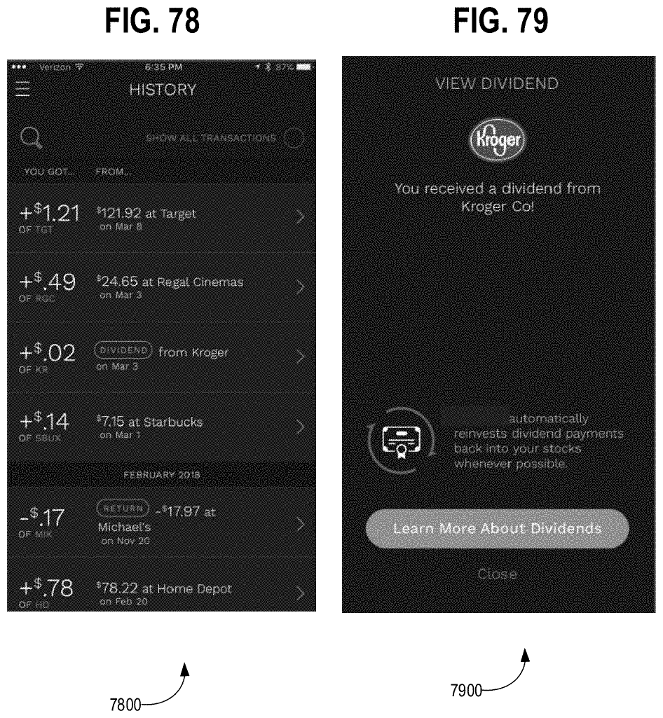

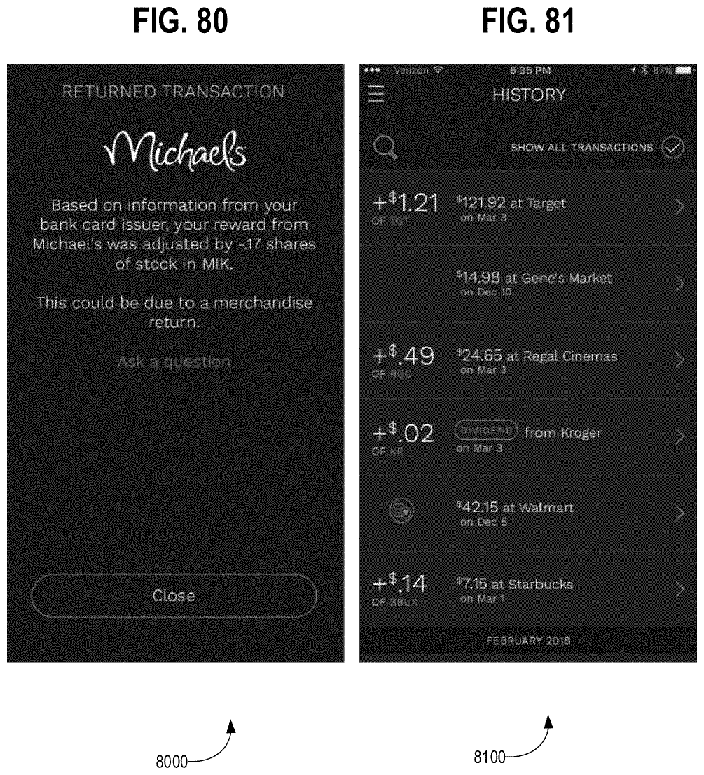

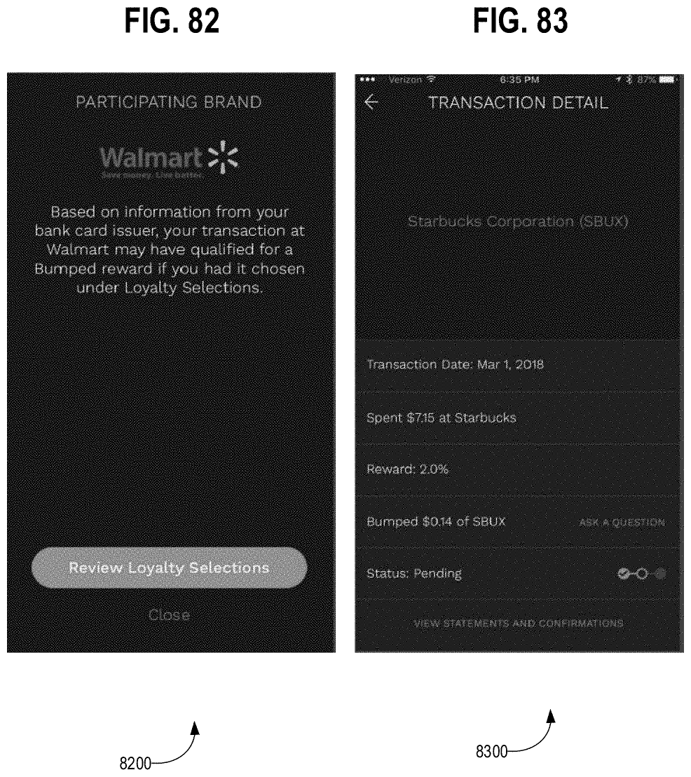

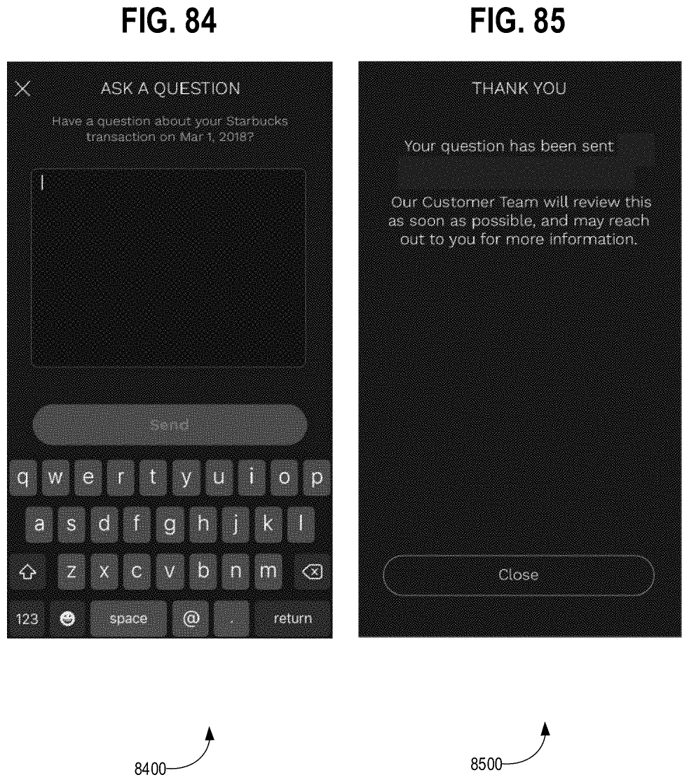

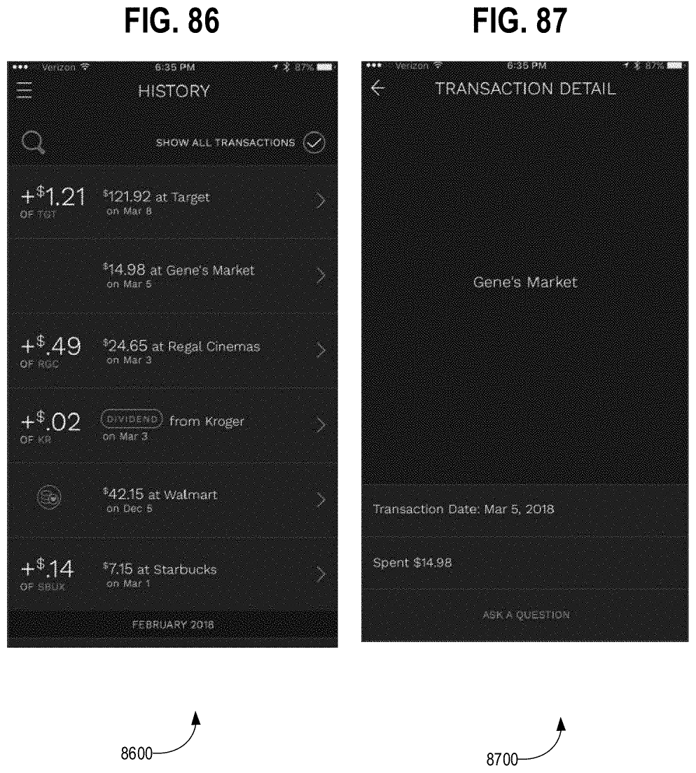

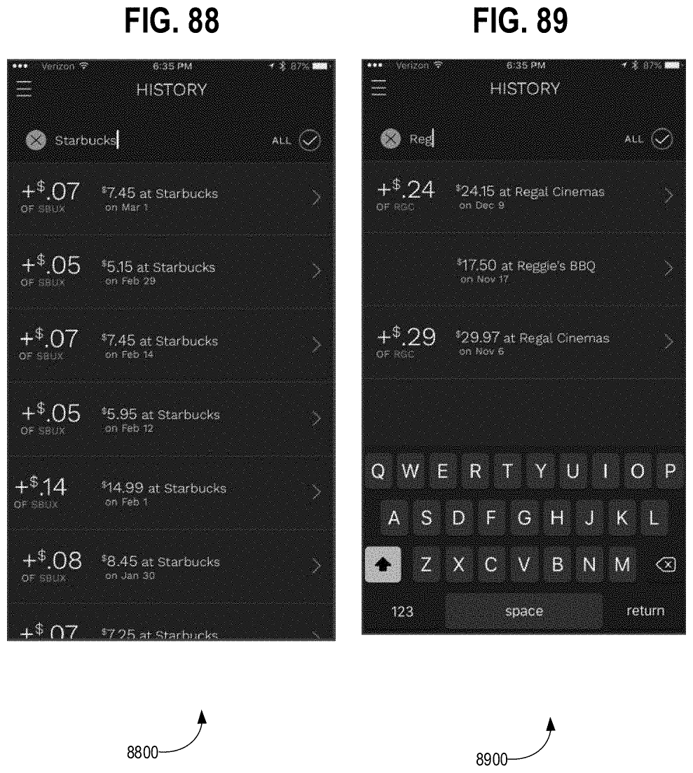

FIGS. 78, 79, 80, 81, 82, 83, 84, 85, 86, 87, 88, and 89 illustrate example graphical user interfaces 7800, 7900, 8000, 8100, 8200, 8300, 8400, 8500, 8600, 8700, 8800 and 8900, which may be displayed by the loyalty platform to illustrate a user's transaction history, including previous tracked purchases, rewards earned based on previous tracked purchases, rewards which could have been earned if a user had selected loyalty to a transacting business, and other such information.

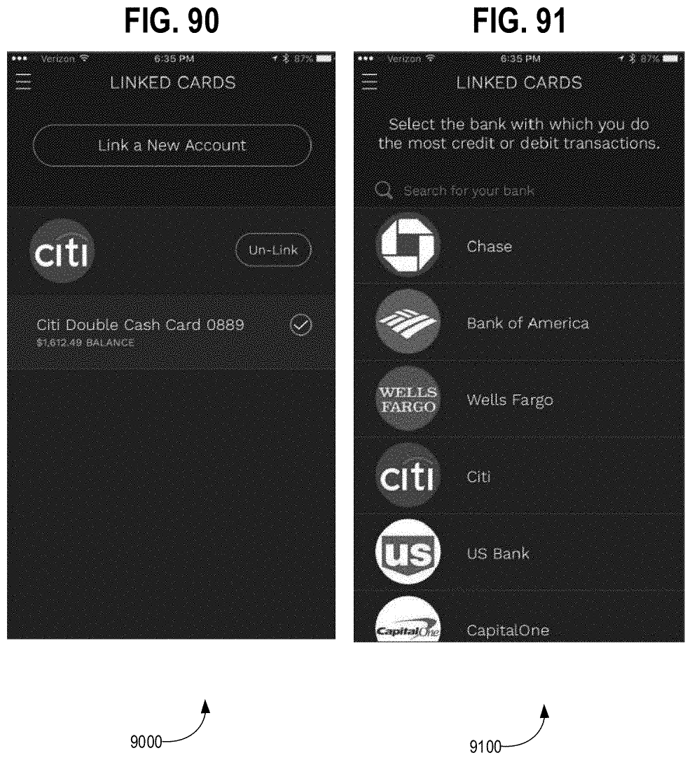

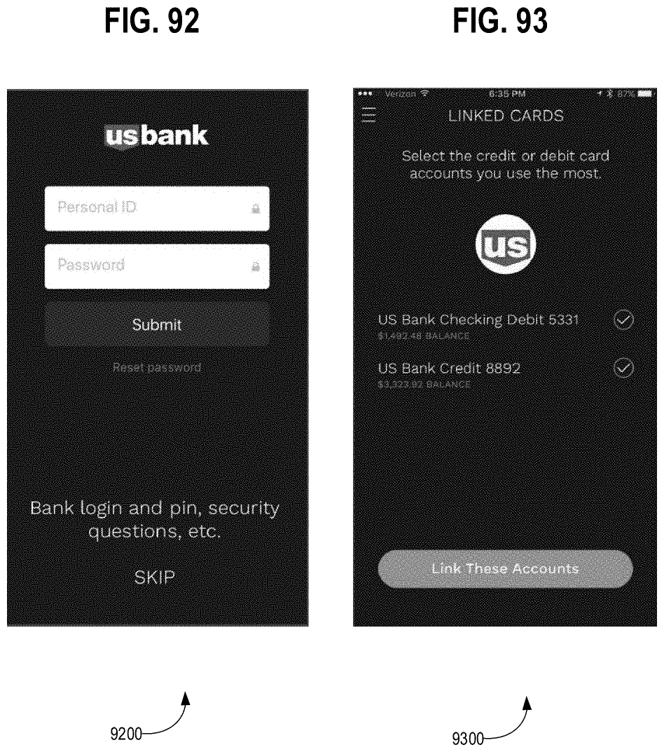

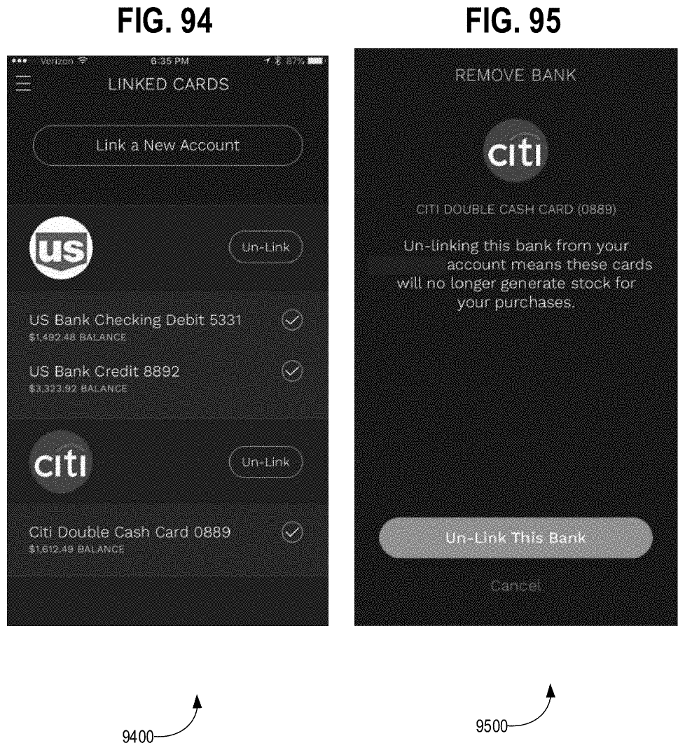

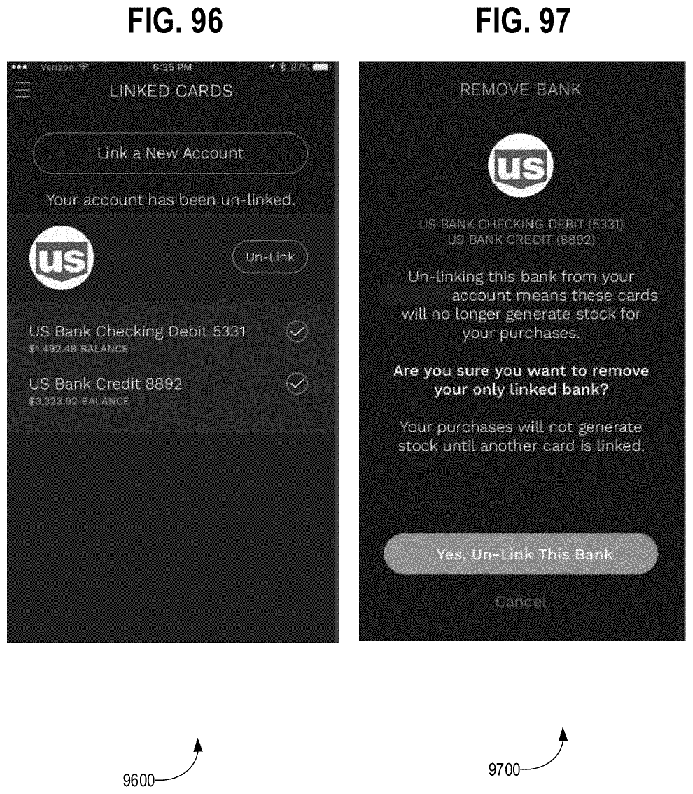

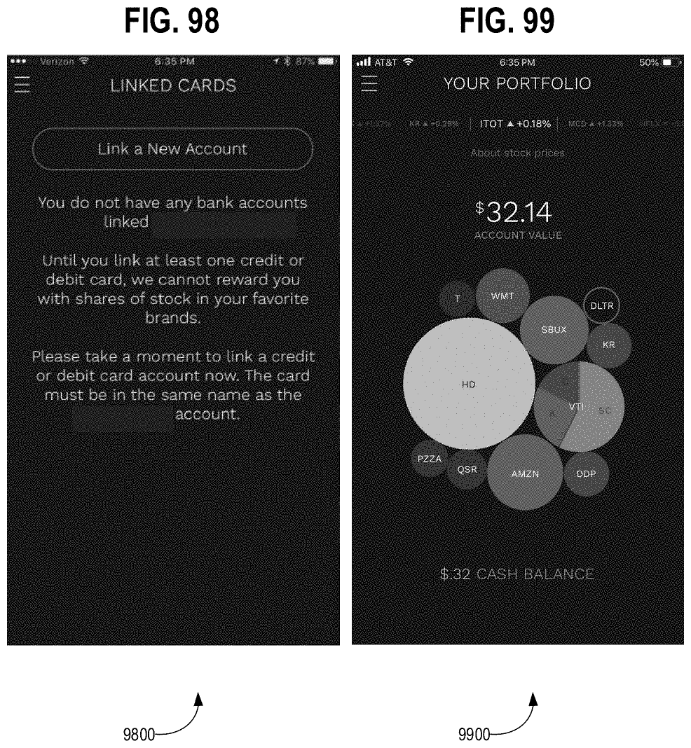

FIGS. 90, 91, 92, 93, 94, 95, 96, 97, and 98, illustrate example graphical user interfaces 9000, 9100, 9200, 9300, 9400, 9500, 9600, 9700, and 9800, which may be displayed by the loyalty platform via a user computing device during a process of managing a user's linked payment media. Said graphical user interfaces may enable viewing, editing, adding, or removing one or more linked payment accounts associated with one or more linked payment media.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method comprising:
determining a first fractional number of shares of stock in a business to reward a user based on a tracked user loyalty purchase conducted by the user with the business;
displaying an equity reward status to the user;
aggregating the first fractional number of shares of stock in the business with one or more pending equity rewards in the business to form an aggregate pending equity reward;
responding to the aggregate pending equity reward being greater than a pending reward threshold by:
purchasing a whole number of shares of stock in the business, wherein the whole number of shares of stock is equal to or greater than the aggregate pending equity reward;
transferring a portion of the whole number of shares of stock to a merchant facilitation account associated with the business;
transferring a remainder of the whole number of shares of stock to a residual account;
distributing the first fractional number of shares of stock in the business to a reward account of the user from the portion in the merchant facilitation account associated with the business; and
displaying an updated equity reward status to the user.

2. The method of claim 1, wherein the portion of the whole number of shares of stock is equal to the aggregate pending equity reward.

3. The method of claim 1, wherein the one or more pending equity rewards in the business comprise a plurality of fractional equity rewards earned by a plurality of users based on a plurality of tracked user loyalty purchases.

4. The method of claim 1, wherein the remainder of the whole number of shares of stock is equal to the difference between the whole number of shares of stock and the aggregate pending equity reward.

5. The method of claim 1, wherein the equity reward status comprises a graphical user interface displaying the first fractional number of shares of stock in the business and an estimated reward fulfillment time.

6. The method of claim 5, wherein the estimated reward fulfillment time is based on a rolling average fulfillment time for previously distributed fractional equity rewards.

7. The method of claim 1, wherein determining the first fractional number of shares of stock in the business to reward the user based on the tracked user loyalty purchase conducted by the user with the business further comprises:
receiving point of sale (POS) data for the user loyalty purchase, wherein the point of sale data includes a product identifier;
correlating the product identifier with the business; and
determining the first fractional number of shares of stock in the business to reward the user based on a monetary value of the user loyalty purchase.

8. The method of claim 7, wherein the product identifier comprises a stock keeping unit (SKU), and wherein correlating the product identifier with the business comprises matching the SKU with an entry in a rewarding-business index of the loyalty platform.

9. The method of claim 1, the method further comprising, liquidating shares of stock in the business from the residual account responsive to aggregated fractional remainders of shares of stock in the business within the residual account exceeding a liquidation threshold.

10. The method of claim 1, wherein displaying the updated equity reward status to the user comprises indicating transfer of the first fractional number of shares of stock in the business to the reward account of the user is complete, and further comprises displaying a total amount of equity in the business accumulated by the user.

11. A method for automatically distributing fractional equity rewards using a loyalty platform, the method comprising:
aggregating a plurality of pending fractional equity rewards to produce an aggregate share amount, wherein the plurality of pending fractional equity rewards comprise fractional shares of stock in a business owed to a plurality of users based on a plurality of tracked user loyalty purchases conducted with the business
rounding-up the aggregate share amount to a number of whole shares of stock in the business;
purchasing the number of whole shares of stock in the business using a clearing system;
storing the number of whole shares of stock in an average price account;
transferring a first portion of shares of the number of whole shares of stock from the average price account to a merchant facilitation account, and leaving a first remainder of shares in the average price account; and
distributing the first portion of shares from the merchant facilitation account amongst the plurality of users based on the plurality of tracked user loyalty purchases.

12. The method of claim 11, the method further comprising debiting a merchant deposit account for a monetary value of the first portion of shares.

13. The method of claim 12, wherein the merchant deposit account comprises an account of the business maintained with the loyalty platform, the merchant deposit account holding an amount of funds.

14. The method of claim 13, the method further comprising replenishing the amount of funds responsive to the amount of funds decreasing to below a threshold.

15. The method of claim 11, wherein the first remainder of shares equals the difference between the number of whole shares of stock and the aggregate share amount.

16. The method of claim 11, the method further comprising:
prior to distributing the first portion of shares amongst the plurality of users, displaying an equity reward status to the plurality of users; and
after distributing the first portion of shares amongst the plurality of users, displaying an updated equity reward status to the plurality of users.

17. The method of claim 11, the method further comprising:
transferring the first remainder of shares from the average price account to a residual account;
aggregating the first remainder of shares with a second remainder of shares to form an aggregate remainder of shares; and
selling a second portion of shares of the aggregate remainder of shares based on the aggregate remainder of shares exceeding a threshold amount of shares, wherein the second portion of shares is a second number of whole shares.

18. A computing system comprising:
a processor;
a network adapter; and
a memory storing instructions executable by the processor to:
determine a first fractional number of shares of stock in a business to reward a user based on a tracked user loyalty purchase conducted by the user with the business;
transmit an equity reward status to a user device via the network adapter;
aggregate the first fractional number of shares of stock in the business with one or more pending equity rewards in the business to form an aggregate pending equity reward; and
respond to the aggregate pending equity reward being greater than a pending reward threshold by:
placing a buy order with a clearing system using the network adapter for a whole number of shares of stock in the business, wherein the whole number of shares of stock is equal to or greater than the aggregate pending equity reward; and
upon execution of the buy order:
transferring a portion of the whole number of shares of stock to a merchant facilitation account associated with the business;
transferring a remainder of the whole number of shares of stock to an residual account;
distributing the first fractional number of shares of stock in the business to a reward account of the user from the merchant facilitation account associated with the business; and
transmitting an updated equity reward status to the user device using the network adapter.

19. The computing system of claim 18, wherein the memory further comprises instructions executable by the processor to:
liquidate shares of stock in the business from the residual account responsive to aggregated fractional remainders of shares of stock in the business within the residual account exceeding a liquidation threshold.

20. The computing system of claim 18, wherein transmitting the updated equity reward status to the user device comprises transmitting via the network adapter a summary of accumulated equity rewards in a user account associated with the user device.
